(19) United States
(12) Patent Application Publication
(10) Pub. No.: US 2026/0319812 A1
(43) Pub. Date: Oct. 15, 2026

(54) MONITORING SAAS APP CONFIGS VIA BROWSER (PAB) USING MULTIMODAL LLMS

(71) Applicant: Palo Alto Networks, Inc., Santa Clara, CA (US)

(72) Inventors: Anurag Mukund Phadke, Sunnyvale, CA (US); Chandan Sajjan Agarwal, Cupertino, CA (US); Vishwa Srikaanth, Milpitas, CA (US); Sreejith Rajkumar, Danville, CA (US)

(21) Appl. No.: 19/179,737

(22) Filed: Apr. 15, 2025

(51) Int. Cl. G06F 9/445

(52) U.S. Cl. CPC G06F 9/44505

(57) ABSTRACT

The present application discloses a method, system, and computer system for monitoring software-as-a-service (SaaS) application configurations via a browser using machine learning models, such as large language models. An example of the method includes (i) automatically onboarding an enterprise software-as-a-service (SaaS) application by determining a set of application settings for the SaaS application based on a screenshot of a settings page for the SaaS application using a machine learning model, (ii) performing a monitoring, using the machine learning model, for an attempt to change the application settings, and (iii) enforcing a policy based at least in part on the monitoring for the attempt to change the application settings.

### BACKGROUND OF THE INVENTION

The proliferation of Software-as-a-Service (SaaS) applications in modern enterprises presents significant challenges in security, compliance, and governance. Many organizations struggle with shadow SaaS adoption, where users deploy SaaS applications without proper oversight, leading to misconfigured settings that may introduce security vulnerabilities, compliance risks, and operational inefficiencies. In particular, SaaS applications that leverage artificial intelligence (AI) can inadvertently expose sensitive data, lack adequate authentication mechanisms, or have improper logging configurations, thereby increasing an organization's risk exposure.

### BRIEF DESCRIPTION OF THE DRAWINGS

Various embodiments of the invention are disclosed in the following detailed description and the accompanying drawings.

FIG. 1 is a block diagram of an environment for providing an application configuration setting security service to a network according to various embodiments.

FIG. 2 is a block diagram of a system for deploying a configuration detector in connection with a security policy enforcement according to various embodiments.

FIG. 3 is a block diagram of a system for deploying a configuration detector in connection with a security policy enforcement according to various embodiments.

FIG. 4 is an example of a prompt for fine-tuning a configuration detector to perform detections with respect to software-as-a-service (SaaS) application configuration settings according to various embodiments.

FIG. 5 is an example of a screenshot of a configuration settings page for a SaaS application.

FIG. 6 is an example of prompts for querying a configuration detector to perform detections with respect to SaaS application configuration settings according to various embodiments.

FIG. 7 is a block diagram of a system for configuration detector for in connection with a security policy enforcement according to various embodiments.

FIG. 8 is a flow diagram of a method for enforcing a policy with respect to SaaS application configuration settings according to various embodiments.

FIG. 9 is a flow diagram of a method for training a configuration detector to perform detections with respect to SaaS application configuration settings according to various embodiments.

FIG. 10 is a flow diagram of a method for training a configuration detector to perform detections with respect to SaaS application configuration settings according to various embodiments.

FIG. 11 is a flow diagram of a method for fine-tuning a configuration detector to perform detections with respect to SaaS application configuration settings according to various embodiments.

FIG. 12 is a flow diagram of a method for onboarding a particular SaaS application according to various embodiments.

FIG. 13 is a flow diagram of a method for onboarding a particular SaaS application according to various embodiments.

FIG. 14 is a flow diagram of a method for monitoring configuration settings for a particular SaaS application according to various embodiments.

FIG. 15 is a flow diagram of a method for monitoring configuration settings for a particular SaaS application according to various embodiments.

FIG. 16 is a flow diagram of a method for enforcing a policy with respect to a detected change to a SaaS application configuration setting according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a security entity may be a network node (e.g., a device) that enforces one or more security policies with respect to information such as network traffic, files, etc. As an example, a security entity may be a firewall. As another example, a security entity may be implemented as a router, a switch, a DNS resolver, a computer, a tablet, a laptop, a smartphone, etc. Various other devices may be implemented as a security entity. As another example, a security may be implemented as an application running on a device, such as an anti-malware application.

As used herein, a model may include a machine learning (ML) model and/or a deep learning model. Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc. The model (e.g., the ML model) may be a large language model (e.g., an LLM) such as a finely-tuned LLM that is configured/tuned for detecting and/or characterizing configuration settings for a software-as-service (SaaS) application.

As used herein, a security policy (or “policy”) may include a set of rules, procedures, and guidelines designed to protect an organization's digital assets, systems, and data from unauthorized access, misuse, or damage. It outlines how sensitive information should be handled, who is allowed to access it, and the measures in place to prevent threats, such as hacking, malware, or data breaches. A security policy can cover various aspects of network security, including access control, encryption, authentication, incident response, and monitoring, with the goal of ensuring the confidentiality, integrity, and availability of the organization's information and resources. By establishing clear protocols, security policies help mitigate risks and ensure that employees, systems, and applications adhere to best practices for safeguarding critical data.

Traditional approaches to auditing and managing Software-as-a-Service (SaaS) application configurations have relied heavily on manual processes and brittle automated techniques, which present significant scalability and accuracy challenges. In related art systems, domain experts or IT administrators manually inspect and document the configuration settings of SaaS applications. This often involves navigating through a web-based user interface, identifying relevant settings, and cross-referencing them with internal security policies. While manual audits provide some level of accuracy, they are time-consuming, prone to human error, and difficult to scale across an organization's ever-growing SaaS ecosystem.

Related art approaches for managing SaaS application configurations typically involve domain experts configuring mechanisms to crawl and extract configuration settings from SaaS applications by analyzing their Document Object Model (DOM). This method necessitates the use of tools such as Beautiful Soup or Selenium to parse and interpret the structure of a settings page, identifying relevant fields and controls. However, these techniques are inherently fragile due to the dynamic and evolving nature of web applications.

SaaS applications frequently update their user interfaces, causing changes in the DOM structure that can break scrapers, requiring constant reconfiguration and maintenance. Additionally, web scraping techniques struggle with the diversity of SaaS platforms. The structure of one application's settings page can differ significantly from another, making it impractical to create a universal scraper. Adapting a scraper to a new application requires significant engineering effort, making this approach inefficient and non-scalable.

One major limitation of existing methods is the high degree of customization required for each individual SaaS application. A scraper built to extract configurations from one application is often not reusable for another due to structural differences in the underlying HTML, JavaScript frameworks, and page layouts. This necessitates frequent reconfigurations and modifications, leading to inefficiencies in scaling across multiple SaaS platforms. Moreover, even within the same application, periodic updates to the user interface can break existing scraping mechanisms, requiring ongoing maintenance and revalidation.

The scalability of traditional scraping approaches is also linear and labor-intensive. Each new application or configuration change requires human intervention, significantly slowing down the adoption of new SaaS applications within an organization. Furthermore, scraping-based methods often fail to provide contextual understanding of configuration settings, as they primarily rely on extracting raw text or form values without semantic interpretation. This limitation hinders the ability to enforce policies effectively, as organizations must manually map extracted values to security and compliance frameworks.

Beyond technical fragility, scraping methods introduce potential security and compliance concerns. Many SaaS applications implement anti-scraping mechanisms to prevent automated access, making it difficult to retrieve configuration settings consistently. Additionally, scraping may inadvertently expose sensitive data by extracting more information than necessary, increasing the risk of compliance violations. These challenges highlight the need for a more intelligent and adaptable approach to detecting and managing SaaS configurations.

Another major limitation of existing techniques is their inability to intelligently interpret and classify SaaS configurations beyond simple text extraction. Even when a scraper successfully identifies a setting, additional work is needed to understand its implications, categorize it according to compliance policies, and determine whether it poses a security or operational risk. Current systems lack the ability to dynamically adapt to new SaaS applications or evolving configuration settings, making them unsuitable for organizations that need real-time visibility and policy enforcement across multiple SaaS platforms.

Given these challenges, there is a need for a more intelligent, scalable, and adaptable system that can automatically detect and characterize SaaS application configurations. Instead of relying on brittle scraping techniques, a system leveraging large language models (LLMs) or other machine learning models can provide a robust, flexible approach to identifying and managing configurations across different SaaS applications. According to various embodiments, the system could extract and classify settings more reliably, adapt to new applications without extensive manual intervention, and enforce compliance policies dynamically. Various embodiments not only improve the efficiency of SaaS configuration management but also enhance security by proactively identifying policy violations and misconfigurations in real time.

According to various embodiments, the system and/or method implements a technique that overcomes these limitations, for example, by leveraging advanced artificial intelligence techniques, including large language models (LLMs), to automatically detect, classify, and monitor SaaS application configurations. Instead of relying on brittle scraping, the system implements machine learning to analyze settings pages, interpret configuration options, and map them to relevant control identifiers. By training on a diverse dataset of SaaS application configurations, the system achieves greater adaptability, scalability, and accuracy compared to traditional approaches.

Through this AI-driven technique, organizations can automate the onboarding of new SaaS applications, continuously monitor configuration changes, and enforce compliance policies with minimal human intervention. The system's ability to process screenshots, extract settings using OCR, and contextualize configurations with LLM-based reasoning ensures a more robust and scalable solution to SaaS configuration management. This represents a significant advancement over existing manual and scraping-based techniques, providing enterprises with an intelligent and proactive approach to securing their SaaS environments.

In some embodiments, the system automates the detection, classification, and management of SaaS application configurations using LLM or other machine learning-based techniques. The system is designed to identify and characterize configurable settings within SaaS applications, mapping each detected configuration to a corresponding control identifier. This automated onboarding process enables enterprises to systematically analyze and govern SaaS application configurations, ensuring alignment with security policies and compliance frameworks.

In some embodiments, the system implements a finely tuned LLM, leveraging concepts of few-shot learning, to analyze and interpret screenshots or images of SaaS application settings pages. This process is augmented with publicly available documentation related to SaaS configurations. The underlying LLM may be adapted from a generic model, such as ChatGPT, Claude, or Llama, and refined to specialize in identifying SaaS configuration settings. In some implementations, using optical character recognition (OCR), the system extracts key-value pairs representing configuration settings, including binary (on/off) switches, dropdown selections, and toggle-based controls.

According to various embodiments, the system supplements LLM-based analysis with external data sources to enhance classification accuracy, thereby mitigating challenges arising from variable font styles, themes (e.g., light vs. dark mode), OCR limitations, and the dynamic introduction of new configuration options in production environments. The system can implement a continuous training of the LLM on diverse SaaS settings pages, and thus can develop a comprehensive understanding of configuration patterns, enabling it to map known settings to control identifiers and generate new control identifiers for previously unseen configurations. Newly detected settings are flagged for further review to ensure proper classification and policy alignment.

In addition to onboarding and classification, the system can implement continuous/recurring monitoring of SaaS application configurations. As an example, the system can monitor user interactions with SaaS settings pages. By tracking user interactions with SaaS settings pages, the system detects configuration changes and determines whether such modifications violate enterprise policies. The system may capture screenshots upon detecting an attempted change and utilize the LLM to assess whether the action complies with predefined security and compliance policies.

The system enforces security policies by integrating with a secure browser or browser extension to monitor and regulate configuration changes. If a user attempts to modify a setting in a manner that results in a policy violation, the system can intervene by intercepting the save operation and restricting the change. In such cases, the system can generate alerts for the user and notify administrators of unauthorized or non-compliant configuration changes. This proactive enforcement mechanism ensures that SaaS applications remain properly configured, minimizing security risks associated with misconfigurations.

Through the combination of automated onboarding, real-time monitoring, and policy enforcement, the system provides enterprises with a robust solution for managing SaaS application configurations. By leveraging advanced AI-driven techniques, the system enables organizations to enhance security posture, improve compliance adherence, and mitigate risks associated with shadow SaaS adoption.

Various embodiments provide a method, system, and computer system for monitoring software-as-a-service (SaaS) application configurations via a browser using machine learning models, such as large language models. An example of the method includes (i) automatically onboarding an enterprise software-as-a-service (SaaS) application by determining a set of application settings for the SaaS application based on a screenshot of a settings page for the SaaS application using a machine learning model, (ii) performing a monitoring, using the machine learning model, for an attempt to change the application settings, and (iii) enforcing a policy based at least in part on the monitoring for the attempt to change the application settings.

Various embodiments provide a method, system, and computer system for training a machine learning model (e.g., an LLM) to detect and/or characterize configuration settings for SaaS applications. The machine learning model may be used to on-board SaaS applications (e.g., mappings of configuration settings for the SaaS applications) and/or to monitor SaaS configuration settings to enforce a policy (e.g., a SaaS configuration settings policy). For example, the machine learning model can be implemented in connection with detecting attempted changes to configuration settings and detecting policy attempts to change the configuration settings that are policy violations (or would result in a policy violation). The method includes (a) obtaining a training set of configuration settings page samples for a set of SaaS applications, (b) obtaining a set of publicly available documentation for a plurality of SaaS applications, and (c) finely tuning a large language model (LLM) to identify SaaS application configurations, wherein the LLM is fine-tuned based at least in part on (i) the training set of configuration settings page samples, and (ii) obtaining a set of publicly available documentation for a plurality of SaaS applications.

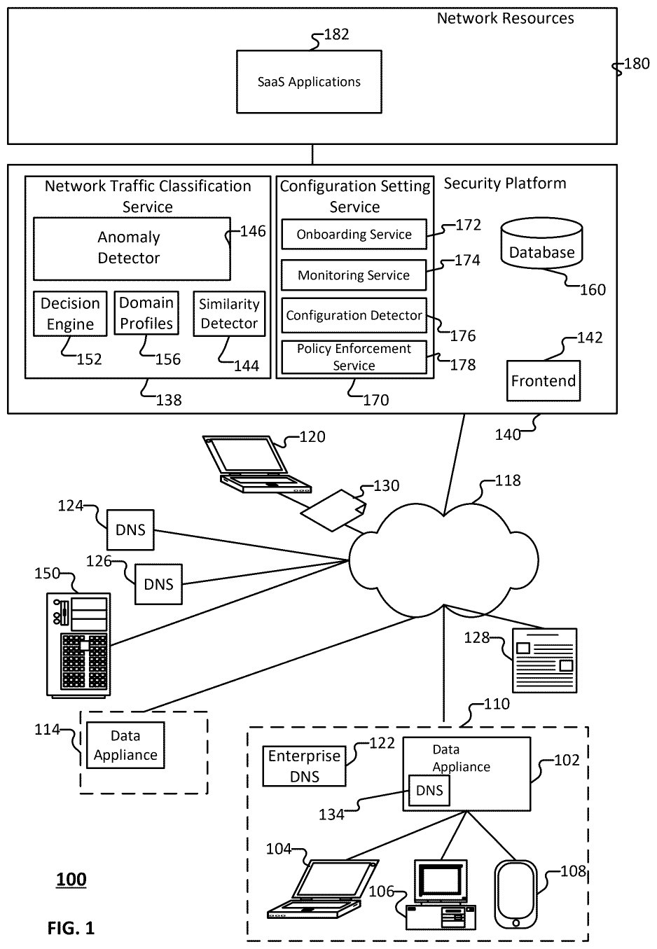

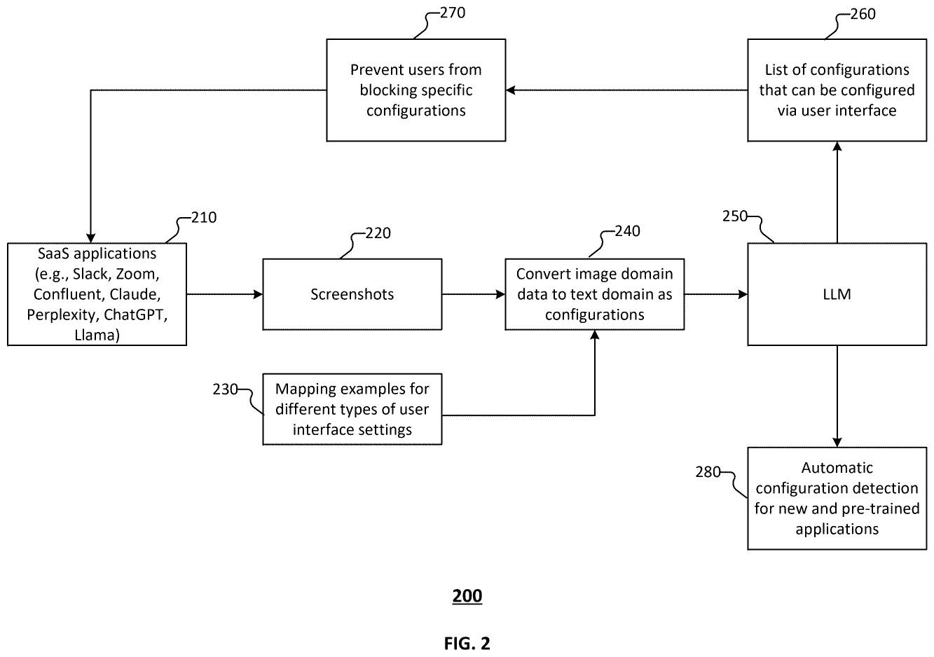

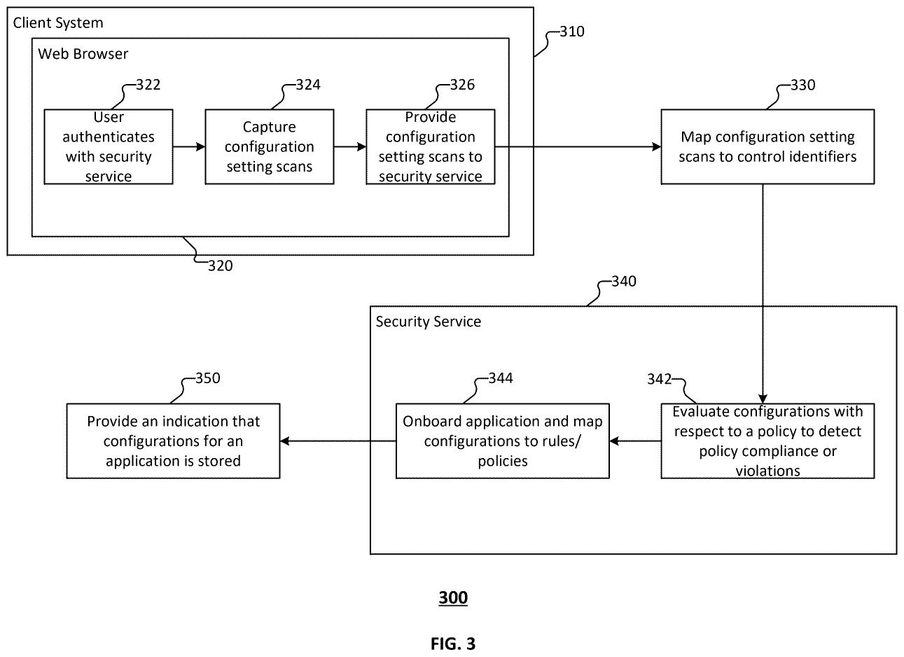

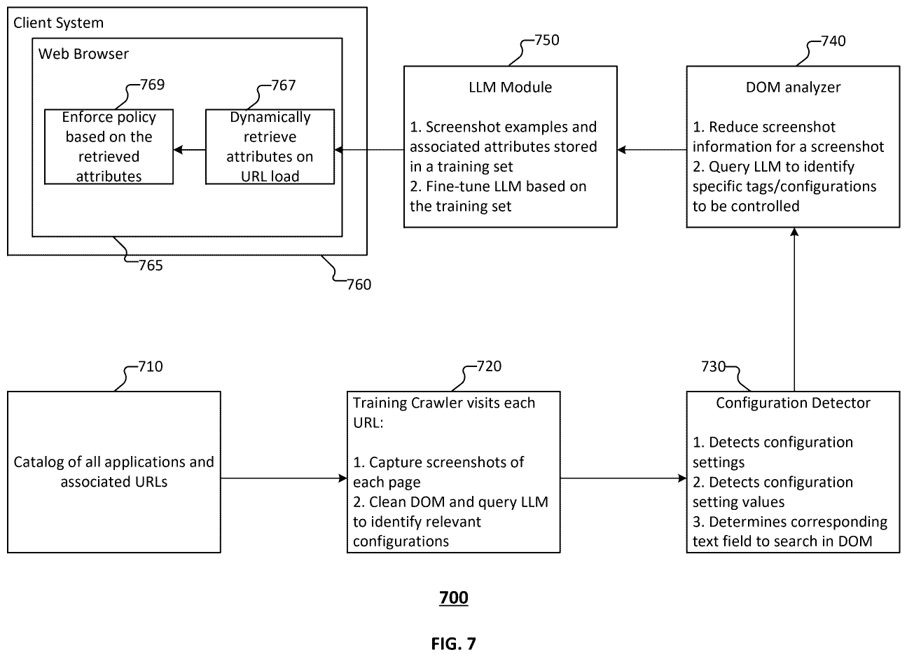

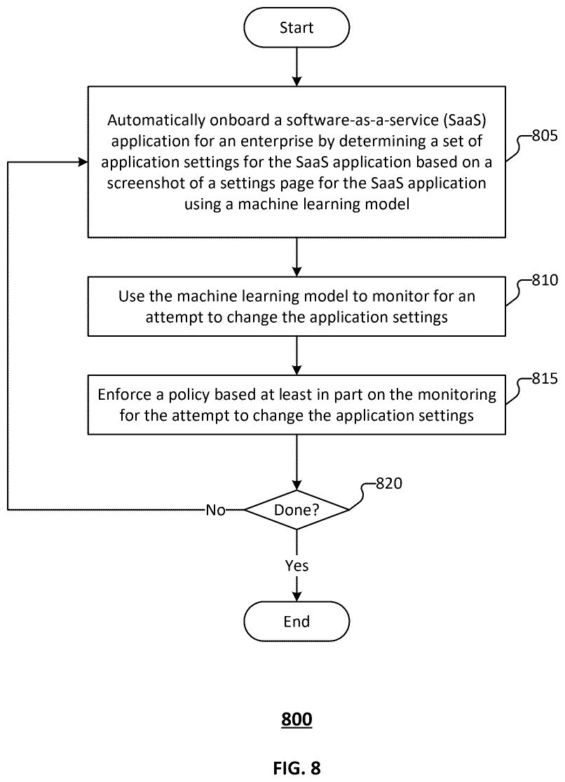

FIG. 1 is a block diagram of an environment for providing an application configuration setting security service to a network according to various embodiments. According to various embodiments, system 100 implements a security service that onboards SaaS applications to a system in which policies are enforced with respect to configuration settings of SaaS applications. System 100 uses a machine learning model (e.g., LLM) to detect configuration settings on a webpage for the SaaS application (e.g., the system uses the LLM to classify a SaaS application webpage and/or identify configuration settings and user interface controls therefor. In some embodiments, system 100 is implemented at least in part by system 200 of FIG. 2, system 300 of FIG. 3, and/or system 700 of FIG. 7. In some embodiments, system 100 implements at least part of one or more of processes 800-1600 of FIGS. 8-16.

Security policies governing SaaS application configuration settings are important for ensuring that cloud-based applications align with an organization's security, compliance, and operational requirements. These security policies define the acceptable configurations for SaaS applications, preventing misconfigurations that could expose sensitive data, weaken authentication mechanisms, or violate regulatory standards. By enforcing security policies at the configuration level, system 100 can enable enterprises to maintain control over their SaaS environments while mitigating security risks associated with improper settings.

One common type of security policy focuses on authentication and access control. Organizations may require that all permitted SaaS applications enforce multi-factor authentication (MFA) for user logins. This security policy ensures that users must provide an additional verification step, such as a one-time passcode, before accessing the application. Another authentication-related policy may mandate that SaaS applications integrate with the organization's single sign-on (SSO) solution, preventing users from creating standalone accounts that bypass centralized identity management controls.

Data security policies govern how information is stored, shared, and accessed within SaaS applications. Enterprises may require that all (or certain) SaaS applications encrypt stored and transmitted data using industry-standard encryption algorithms. Additionally, organizations may configure system 100 to implement security policies that restrict external sharing of sensitive documents or customer data, ensuring that files containing personally identifiable information (PII) or proprietary business data cannot be shared with unauthorized users or external domains.

Logging and auditing security policies ensure that SaaS applications maintain detailed records of user activity, enabling security teams to monitor access and detect potential threats. Organizations may require that all (or certain) SaaS applications generate audit logs for login attempts, administrative actions, and configuration changes. In some instances, these logs must be retained for a specified period to comply with regulatory requirements such as GDPR, HIPAA, or SOC 2. The security policy may also specify that logs be integrated with a centralized security information and event management (SIEM) system for continuous monitoring and threat detection.

Application security policies govern the exposure of application features and integrations that could introduce vulnerabilities. For example, an organization may enforce a policy that disables public API access unless explicitly approved. This prevents unauthorized third parties from interacting with the SaaS application's backend. Similarly, enterprises may configure system 100 to restrict the installation of third-party integrations that have not been vetted for security risks, ensuring that only approved plugins and extensions can be enabled within the SaaS environment.

Usage and compliance policies define acceptable use cases for SaaS applications within an organization. Some enterprises may prohibit the use of generative AI features in certain SaaS applications due to concerns about data privacy and intellectual property risks. Others may enforce policies that prevent users (e.g., employees) from enabling beta or experimental features that have not been reviewed for security implications. Compliance policies may also specify geographic data residency requirements, ensuring that SaaS applications store data only in approved regions to comply with local data protection laws.

By implementing these security policies, enterprises can ensure that their SaaS environments remain secure, compliant, and aligned with business objectives. The ability of system 100 to continuously monitor and enforce these policies through automated detection and remediation mechanisms helps organizations prevent misconfigurations before they lead to security breaches. As SaaS applications evolve, enterprises must continuously assess and update their policies to address new risks while maintaining flexibility for innovation and operational efficiency.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively blocking or sinkholing traffic, such as traffic to malicious domains, DNS hijacked domains, stockpiled domains, or squatting domains, or such as traffic for certain applications (e.g., SaaS applications). In some embodiments, data appliance 102 is also configured to enforce policies with respect to traffic that stays within (or from coming into) enterprise network 110.

System 100 comprises a security platform 140 that can provide security services for network resources 180 (e.g., a cloud infrastructure), such as software-as-a-service (SaaS) applications 182. For example, security platform 140 can perform authentication services for authentication of endpoints, such as client devices 104-108, in connection with providing access to network resources 180. As another example, security platform 140 can manage access policies, including dynamically provisioning access policies for ad hoc user access requests. As another example, security platform 140 can enforce security policies with respect to user interactions with SaaS applications 182, for example, to ensure that configuration settings of SaaS applications 182 remain compliant with the security policies.

Techniques described herein can be used in conjunction with a variety of platforms (e.g., desktops, mobile devices, gaming platforms, embedded systems, etc.) and/or a variety of types of applications (e.g., Android .ask files, iOS applications, Windows PE files, Adobe Acrobat PDF files, Microsoft Windows PE installers, etc.). In the example environment shown in FIG. 1, client devices 104-108 are endpoints, such as a laptop computer, a desktop computer, and a tablet (respectively) present in an enterprise network 110. Client device 120 is a laptop computer present outside of enterprise network 110.

Data appliance 102 (e.g., a security entity) can be configured to work in cooperation with remote security platform 140. Security platform 140 can provide a variety of services, including authenticating endpoints, provisioning access policies for accessing network resources 180, providing secure access to network resources 180, auditing use of provisioned access policies, auditing access events to network resources 180, resolving DNS queries, providing DNS resolving security services, classifying domains (e.g., predicting whether a domain is a malicious domain, etc.), classifying DNS response records (e.g., predicting whether a domain IP pair in a DNS response is a DNS hijacked record, etc.), classifying network traffic, classifying DNS traffic, providing a mapping of signatures to certain domains or DNS records, performing static and dynamic analysis on malware samples, monitoring new domains and new DNS records (e.g., detecting new domains for which a certificate is issued/generated), assessing maliciousness of domains, determining whether a DNS record associated with a traffic sample is (or is likely to be) a DNS hijacked record, detecting squatting domains, detecting a DNS cache poisoning attack (e.g., an attempt or a DNS cache entry stored based on an effective DNS cache poisoning attack), providing a list of signatures of known exploits (e.g., malicious input strings, malicious files, malicious domains, etc.) to data appliances, such as data appliance 102 as part of a subscription, detecting exploits such as malicious input strings, malicious files, DNS hijacked records or malicious domains (e.g., an on-demand detection, or periodical-based updates to a mapping of domains or DNS records to indications of whether the domains or DNS records are malicious or benign), providing a likelihood that DNS traffic (e.g., a domain or DNS record comprised in the DNS traffic) is malicious or benign, providing/updating a whitelist of input strings, files, or domains deemed to be benign, providing/updating input strings, files, or domains deemed to be malicious, identifying malicious input strings, detecting malicious input strings, detecting malicious files, predicting whether input strings, files, DNS records, or domains are malicious, providing an indication that an input string, file, DNS record, or domain is malicious (or benign), etc.

In some embodiments, network security services, such as authentication services, are implemented at data appliance 102. As an example, data appliance 102 can authenticate endpoints for access to network resources 180. The authentication services may include performing IKEv2 authentication for the endpoints.

In some embodiments, network security services are implemented by one or more servers, such as a cloud service. Examples of the network security services include one or more of: (a) obtaining a request to access a SaaS application, (b) determining a webpage/URL of the SaaS application to which a user is navigating, (c) determining whether the webpage corresponds to a configuration settings page (e.g., a page via which a configuration setting of the SaaS application can be changed, such as via user input to a user interface), (d) receiving (e.g., intercepting) a request or other user input with respect to a webpage of the SaaS application, (e) determining whether the request or other user input with respect to a webpage of the SaaS application is to update a configuration setting (e.g., is an input to a configuration setting control to change a value for the configuration setting), (f) determining whether a user input/command to update a configuration setting is compliant with one or more security policies, (g) determining how to handle the user input/command to update the configuration setting based on a determination of whether such an update is compliant with the one or more security policies (e.g., if the update is an attempt that would render the configuration setting non-compliant, system 100 can drop the user input/request or otherwise restrict the change to the configuration setting; and if the update is an attempt that would not render the configuration setting non-compliant, system 100 can forward the user input/command to the SaaS application to correspondingly set the configuration setting).

Additional examples of the network security services include one or more of: (a) determining to onboard a SaaS application or update a mapping of configuration settings for an already onboarded SaaS application, (b) determine a set of URLs/webpages for the SaaS application to be onboarded (e.g., all the URLs for the SaaS application), (c) traverse the set of URLs (e.g., traverse all the webpages for the SaaS application) and crawl the corresponding webpages to collect SaaS application information (e.g., configuration setting information, such as webpage metadata, a screenshot, etc.), (d) capture screenshots for the crawled webpages, (e) convert information comprised in the screenshot from an image domain to a text domain (e.g., implement an OCR technique to determine text comprised in the SaaS application), (f) prompt a machine learning model (e.g., an LLM) to detect configuration settings on the captured screenshots, and (h) map identified/detected configuration settings to webpages and control identifiers (or configuration identifiers).

In various embodiments, results of analysis (and additional information pertaining to applications, domains, etc.), such as an analysis or classification performed by security platform 140, are stored in database 160. In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware Six, Citrix eServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

According to various embodiments, security platform 140 comprises/implements network traffic classification service 138 and/or configuration setting service 170. Security platform 140 may include various other services/modules, such as a malicious file detector, a malicious traffic detector, a parked domain detector, an application classifier or other traffic classifier, etc.

Network traffic classification service 138 is used in connection with analyzing network traffic (e.g., websites, domains, sample files, etc. pertaining to the network traffic) and/or automatically detecting malicious network traffic. For example, network traffic classification service may include anomaly detector 145, decision engine 152, domain profiles 156, and/or similarity detector 144.

Configuration setting service 170 is used in connection with mapping configuration settings for SaaS applications (e.g., SaaS applications 182 that are to be made available by an organization) and dynamically enforcing security policies, for example, with respect to attempts to change SaaS application configuration settings.

In some embodiments, configuration setting service 170 comprises one or more of onboarding service 172, monitoring service 174, configuration detector 176, and policy enforcement service 178.

Configuration setting service 170 uses onboarding service 172 to onboard SaaS applications for dynamic enforcement of security policies with respect to SaaS applications, and in particular, with respect to change management of configuration settings for the SaaS applications. Onboarding service 172 can obtain a set of one or more SaaS applications to be onboarded, for example, based on a user input or a predefined list of SaaS application such as SaaS applications authorized/deployed by an organization. In response to determining that a SaaS application is to be onboarded (or a mapping of configuration settings is to be updated for an already onboarded SaaS application), onboarding service 172 determines the webpages for the SaaS application (e.g., identifies all webpages/URLs accessible for the SaaS application), traverses and crawls a webpage for the SaaS application (e.g., iteratively crawls each of the identified SaaS application webpages), and captures SaaS application information for the webpage(s). In some embodiments, the SaaS application information comprises screenshots for the crawled webpages. The SaaS application information may additionally include webpage metadata or supplemental documentation for the SaaS application (e.g., user guides, etc.). Onboarding service 172 can query configuration detector 176 to detect configuration settings and controls therefor on the various screenshots for the SaaS application webpages. In response to receiving the configuration settings, onboarding service 172 can store a mapping of configuration settings to SaaS applications, including a mapping of configuration settings (and controls therefor) to SaaS application webpages (e.g., to identify those webpages comprising configuration settings controls) and/or a mapping of configuration settings to control identifiers (or configuration identifiers).

Configuration setting service 170 uses monitoring service 174 to monitor user interaction with SaaS application, for example, to detect whether the user is attempting to change a configuration setting for which a security policy is to be enforced. Monitoring service 174 can intercept a user input (e.g., a command/request generated at the client system). In response to intercepting the user input, monitoring service determines whether the user input corresponds to an attempt to change a configuration setting (e.g., an input to a corresponding configuration setting control). In some embodiments, the user input is intercepted at the client system by a browser extension or a protected browser, which forwards the input (e.g., the command/request) to security platform 140 for analysis and mediation.

Configuration setting service 170 uses configuration detector 176 to detect configuration settings for a SaaS application. In some embodiments, configuration detector 176 can detect the configuration settings for the onboarding of SaaS applications or the updating of mapping of configuration settings for the configuration detector. In some embodiments, configuration detector 176 detects the configuration settings in connection with dynamic monitoring of user interaction with SaaS applications for policy enforcement. For example, configuration detector 176 can receive a snapshot captured by a client system (e.g., a browser extension or a protected browser) and detect whether the snapshot corresponds to a page in which the SaaS application configuration settings can be controlled (e.g., configuration detector 176 can query an LLM to classify the snapshot or information obtained from the snapshot).

Configuration setting service 170 uses policy enforcement service 178 to enforce a policy with respect to configuration settings. In response to receiving a user input to a SaaS application webpage, configuration setting service 170 uses policy enforcement service 178 to determine a manner for handling the user input (e.g., a command/request to change a configuration setting) based at least in part on one or more policies to be enforced for the SaaS application and/or the particular configuration setting type that the user is attempting to configure.

Network traffic classification service 138 may comprise an anomaly detector 146 (e.g., configured to detect anomalies in network traffic, file samples obtained by intercepting traffic, DNS traffic, or DNS records, etc.), a decision engine 152 (e.g., configured to predict whether network traffic, intercepted file samples, or whether a DNS record is malicious), domain profiles 156, and/or a similarity detector 144. In some embodiments, network traffic classification service 138 detects malicious network traffic or malware obtained from intercepted network traffic (e.g., by classifying a file sample obtained by a security entity or other network node requesting a maliciousness classification).

Network traffic classification service 138 can determine the classification for network traffic (e.g., a file sample obtained from network traffic, a DNS record, a DNS query, a DNS response, a website content, etc.) based at least in part on querying a classifier(s). The classifier that is queried to provide a classification of the network traffic sample associated with the network activity is a fingerprinting-based classifier, a heuristics-based classifier, another rule-based classifier, and/or a machine-learning based classifier. The classifier may be trained based at least in part on historical samples (e.g., samples of network traffic samples extracted from network traffic). The classifier can be trained based at least in part on a machine learning process.

The classifier(s) may implement one or more machine learning models that may be trained according to a machine learning process. Examples of machine learning processes that can be implemented include random forest, linear regression, support vector machine, naive Bayes, logistic regression, K-nearest neighbors (KNN), decision trees, gradient boosted decision trees, K-means clustering, hierarchical clustering, density-based spatial clustering of applications with noise (DBSCAN) clustering, principal component analysis, a neural network (NN), XGBoost, a convolutional neural network (CNN), and LLM etc.

According to various embodiments, security platform 140 may receive a query from a security entity (e.g., inline firewall, such as a next generation firewall) for a real-time or offline classification of a network traffic sample, such as a file.

According to various embodiments, in response to network traffic classification service 138 classifying the network traffic sample, system 100 handles the corresponding network traffic according to a predefined policy (e.g., a security policy). For example, in response to predicting that the network traffic sample corresponds to malicious network traffic (e.g., that the domain associated with the network traffic is a squatting domain), system 100 can cause the network traffic to be blocked or quarantined, etc. As another example, system 100 can cause traffic to/from a compromised host (e.g., the client system associated with the intercepted network traffic from which the malicious domain was extracted) to be quarantined or sinkholed, etc. (e.g., at least until an administrator actively configures system 100 to proceed with permitting traffic to/from the client system, such as in response to the compromised host being remediated).

According to various embodiments, in response to network traffic classification service 138 classifying the network traffic (e.g., the network traffic sample, or a domain associated with the network traffic sample), system 100 handles the network traffic according to a predefined policy (e.g., a security policy). For example, the system queries a traffic handling policy to determine the manner by which the network traffic (e.g., network activity for a session associated with the network traffic sample) is to be handled. The traffic handling policy may be a predefined policy, such as a security policy, etc. The traffic handling policy may indicate that network traffic associated with certain domains (e.g., domains classified as squatting domains) or having certain characteristics/profiles is to be blocked and network traffic associated with other domains (e.g., domains not deemed to be squatting domains or otherwise malicious) or having other characteristics/profiles is to be permitted to pass through the system (e.g., routed normally). The traffic handling policy may correspond to a repository of a set of policies to be enforced with respect to network traffic. In some embodiments, security platform 140 receives one or more policies, such as from an administrator or third-party service, and provides the one or more policies to various network nodes, such as endpoints, security entities (e.g., inline firewalls), etc.

In response to determining a classification for a newly analyzed network traffic sample (e.g., a newly analyzed domain for a particular network traffic sample, such as a DNS request or DNS response), security platform 140 (e.g., network traffic classification service 138) sends an indication that network activity (e.g., other network traffic samples) associated with the domain are associated with, or otherwise correspond to, the determined classification. Security platform 140 can provide an indication that network traffic matching the network traffic sample predicted to be malicious (e.g., network traffic matching a domain predicted to be a squatting domain) is to be handled as a malicious network traffic. For example, security platform 140 determines (e.g., computes) a signature or identifier for the network traffic/activity (e.g., a hash or other signature, or identifier for the corresponding network session or domain), and sends to a network node (e.g., a security entity, an endpoint such as a client device, etc.) an indication of the classification associated with the signature (e.g., an indication whether the network traffic/activity is a malicious or non-malicious). Security platform 140 may update a mapping of signatures to network traffic sample classifications and provide the updated mapping to the security entity. In some embodiments, security platform 140 further provides to the network node (e.g., security entity, client device, etc.) an indication of a manner by which network traffic/activity matching the network traffic sample or otherwise be associated with the same session as the network traffic sample classified as malicious or matching the signature is to be handled. For example, security platform 140 provides to the security entity a traffic handling policy, a security policy, or an update to a policy.

According to various embodiments, in response to determining the maliciousness classification for a network traffic sample (e.g., obtaining the predicted maliciousness classification, such as from a classifier), network traffic classification service 138 provides an indication of the maliciousness classification, such as to the applicable security entity (e.g., the security entity that provided the network traffic sample or a security entity mediating network traffic for the session associated with the network traffic sample).

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within enterprise network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable. In some embodiments, configuration setting service 170 is implemented at enterprise DNS server 122 rather than, or in addition to, being implemented at security platform 140.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104′s request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious domains, detecting parked domains, or otherwise determining that certain detected network traffic is to be further analyzed (e.g., using a finer detection model).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

According to various embodiments, a security entity and/or network node (e.g., a client, device, etc.) handles a file based at least in part on an indication that the file is malicious and/or that the file matches a file indicated to be malicious. In response to receiving indication that the file (e.g., the sample is malicious), the security network and/or network node may update a mapping of files to an indication of whether the corresponding file is malicious, and/or a blacklist of files. In some embodiments, the security entity and/or the network node receives a signature pertaining to a file (e.g., a sample deemed to be malicious), and the security entity and/or the network node stores the signature of the file for use in connection with detecting whether files obtained, such as via network traffic, are malicious (e.g., based at least in part on comparing a signature generated for the file with a signature for a file comprised in a blacklist of files). As an example, the signature may be a hash.

Security entities (e.g., firewalls) typically deny or permit network transmission based on a set of rules. These sets of rules are often referred to as policies (e.g., network policies, network security policies, security policies, etc.). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies.

Security devices (e.g., security appliances, security gateways, security services, and/or other security devices) can include various security functions (e.g., firewall, anti-malware, intrusion prevention/detection, Data Loss Prevention (DLP), and/or other security functions), networking functions (e.g., routing, Quality of Service (QoS), workload balancing of network related resources, and/or other networking functions), and/or other functions. For example, routing functions can be based on source information (e.g., IP address and port), destination information (e.g., IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform state-based packet inspection in which each packet is examined within the context of a series of packets associated with that network transmission's flow of packets. This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content (e.g., next generation firewalls). In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls). For example, Palo Alto Networks' next generation firewalls enable enterprises to identify and control applications, users, and content-not just ports, IP addresses, and packets-using various identification technologies, such as the following: APP-ID for accurate application identification, User-ID for user identification (e.g., by user or user group), and Content-ID for real-time content scanning (e.g., controlling web surfing and limiting data and file transfers). These identification technologies allow enterprises to securely enable application usage using business-relevant concepts, instead of following the traditional approach offered by traditional port-blocking firewalls. Also, special purpose hardware for next generation firewalls (implemented, for example, as dedicated appliances) generally provide higher performance levels for application inspection than software executed on general purpose hardware (e.g., such as security appliances provided by Palo Alto Networks, Inc., which use dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' VM Series firewalls, which support various commercial virtualized environments, including, for example, VMware® ESXi™ and NSX™, Citrix® Netscaler SDX™, KVM/OpenStack (Centos/RHEL, Ubuntu®), and Amazon Web Services (AWS)). For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

FIG. 2 is a block diagram of a system for deploying a configuration detector in connection with a security policy enforcement according to various embodiments. According to various embodiments, system 200 is implemented at least in part by one or more of system 100 of FIG. 1, system 300 of FIG. 3, and/or system 700 of FIG. 7. In some embodiments, system 200 implements at least part of one or more of processes 800-1600 of FIGS. 8-16.

In some embodiments, system 200 implements a service for onboarding SaaS applications for policy enforcement with respect to SaaS application configuration settings, and a service for enforcing a security policy with respect to a SaaS application, for example, by ensuring that the SaaS application configuration settings (and changes thereto) are compliant with one or more applicable security policies.

At 210, system 200 identifies SaaS applications with respect to which one or more security policies are to be enforced. System 200 determines SaaS applications to be onboarded or updated (e.g., based on changes to SaaS application configuration settings layouts, etc.) for policy enforcement. These SaaS applications can be determined based on a user input (e.g., an administrator configuring a SaaS application for onboarding) or a predefined list, such as a list of an organization's authorized SaaS applications. Examples of SaaS applications include Slack, Zoom, Confluent, Claude, Perplexity, ChatGPT, Llama, etc. Various other SaaS applications may be implemented.

At 220, system 200 captures screenshots for an SaaS application to be onboarded/updated. System 200 can traverse all the webpages for the SaaS application and capture screenshots and, optionally, additional supplemental webpage information (e.g., webpage metadata) for the SaaS application. For example, system 200 determines the URLs for each webpage for the SaaS application, and navigates to each of the URLs can captures the screenshots.

At 230, system 200 obtains a mapping of examples of different types of user interface settings. The mapping of examples of different types of user interface settings can be pre-stored, such as based on historical onboarding of SaaS applications or historical SaaS application configuration setting classifications/identifications. System 200 can use the mapping of examples of different types of user interface settings in connection with analyzing the captured screenshots for a SaaS application being onboarded.

At 240, system 200 converts the screenshots for a particular SaaS application from image domain data to text domain as configurations. For example, system 200 can implement an optical character recognition (OCR) technique to convert the screenshots to the text domain.

At 250, system 200 implements a machine learning model (e.g., an LLM) to classify/identify configuration settings for the applicable SaaS application(s). For example, the system uses the SaaS application information (e.g., the configuration setting information) obtained by converting screenshots to the text domain to identify the configuration settings and associated controls and values for the SaaS application(s).

In some embodiments, system 200 omits the conversion of the conversion of screenshots to the text domain and instead implements a visual LLM (which itself may convert the data from the image domain to the text domain) to classify the SaaS applications (e.g., identify configuration settings, etc.) based on the captured screenshots.

At 260, system 200 stores a list/mapping of configurations that can be configured for a particular SaaS application via a user interface. For example, the system 200 obtains the list of such configurations from the LLM (e.g., based on an output of the classification/identification obtained by using the LLM to analyze the screenshots or associated text domain information). In some embodiments, system 200 stores a mapping of configurations to configuration identifiers—for example, system 200 stores a mapping of a particular configuration that can be controlled with a unified identifier that indicates a type of configuration (e.g., configurations for MFA or 2FA can be mapped to a same identifier corresponding to a multi-factor authentication configuration, etc.).

At 270, system 200 can enforce one or more security policies with respect to a SaaS application, for example, based on the list of configurations that can be configured via a user interface for such SaaS application. Security policies may define restrictions based on a configuration identifier basis and system 200 uses the list of configurations (e.g., the mapping of SaaS application configuration settings to the appropriate configuration identifiers) in connection with monitoring interaction with the SaaS application to ensure that the SaaS configuration settings are compliant with the applicable security policy(ies). In embodiments, system 200 webpage information (e.g., a URL, a screenshot, webpage metadata, etc.) for a webpage being displayed for a SaaS application, identifies the webpage as a page via which a configuration setting can be configured/set via user interface, and monitors the interactions with the configuration setting. System 200 can monitor the interaction with the configuration setting based at least in part on intercepting a user input (e.g., a command/request) associated with (e.g., input to the configuration setting control for) the configuration setting, and enforce the security policy(ies) in connection with determining whether to implement the user input. For example, system 200 intercepts the user input and determines whether to restrict the user input from being passed to the SaaS application.

At 280, system 200 can implement an automatic configuration detection for new and pre-trained applications. For example, system 200 can determine whether a SaaS application layout has changed (e.g., if the controls for configuration settings are moved to different pages, respectively) or whether a new SaaS application configuration setting that can be controlled via user interface has been added. System 200 can update its list of configurations accordingly, such as updating the mapping of SaaS application pages to configuration settings, or particular configuration settings to configuration identifiers.

FIG. 3 is a block diagram of a system for deploying a configuration detector in connection with a security policy enforcement according to various embodiments. According to various embodiments, system 300 is implemented at least in part by one or more of system 100 of FIG. 1, system 200 of FIG. 2, and/or system 700 of FIG. 7. In some embodiments, system 300 implements at least part of one or more of processes 800-1600 of FIGS. 8-16.

In the example shown, system 300 comprises client system 310. Client system 310 may be an endpoint via which a user accesses a SaaS application. Client system 310 may have a web browser 320, which system 300 uses in connection with enforcing one or more security policies with respect to the SaaS application. For example, web browser 320 may be configured with an extension used by system 300 to monitor user interaction with the SaaS application and cause the security policy control to be enforced. As another example, web browser 320 is a protected browser via that is configured to enable system 300 to monitor user interaction with the SaaS application and cause the security policy control to be enforced.

At 322, a user via web browser 320 authenticates with the security service (e.g., a cloud security service implemented by system 300) that causes one or more security policies with respect to a SaS application. In connection with onboarding or discovery of new SaaS applications or in connection with enforcing a security policy, at 324, system 300 (e.g., via web browser 320) captures configuration setting scans. The configuration setting scans may include screenshots of one or more web pages for the SaaS application (e.g., screenshots of webpages obtained by traversing all URLs associated with the SaaS application) and/or webpage metadata or other supplemental information associated with the SaaS application. At 326, the configuration setting scans are provided to the security service. The security service may use the configuration setting scans to onboard a SaaS application (e.g., to identify/detect configuration setting controls, etc.) and/or to enforce a security policy, such as to determine whether to allow a particular user interaction with respect to a configuration setting.

System 300 uses a configuration setting service 330 to map configuration setting scans to control identifiers. For example, configuration setting service 330 analyzes the configuration setting scans to identify configuration settings and to determine whether and how those configuration settings map to a set of predefined control identifiers. These mappings can be used in connection with onboarding a SaaS application, such as to identify those configuration settings for which a security policy is to be enforced and/or to enforce a security policy for an already onboarded SaaS application.

According to various embodiments, system 300 comprises security service 340. At 342, security service 340 uses the mapping of configuration settings to control identifiers to evaluate configurations with respect to a security policy to detect policy compliance or violations. For example, security service 340 can receive an indication of the user inputs to the SaaS application configuration settings via web browser 320 and can evaluate whether a particular user input is compliant with a particular security policy. Security service 340 can, based on the security policy and the corresponding configuration setting/control identifier associated with the user input, determine whether to permit transmission of the user input to the SaaS application for implementation or whether to drop or restrict transmission for the user input.

At 344, security service 340 onboards a SaaS application, for example, by mapping configurations (e.g., configuration settings or controls therefor) to predefined rules and/or policies. Security service 340 can use the mapping of configuration setting scans to control identifiers to determine those SaaS application configurations settings that are to be monitored and mediated for policy compliance. For example, security service 340 can use the results of the evaluation of the configurations with respect to a predefined policy or rule to determine those SaaS application configurations settings that are to be monitored and mediated for policy compliance.

At 350, system 300 provides an indication that configuration for a SaaS application is stored. For example, system 300 provides an indication that the SaaS application has been onboarded and the determination of SaaS configuration settings for which the one or more policies (e.g., security policies) are to be enforced is complete.

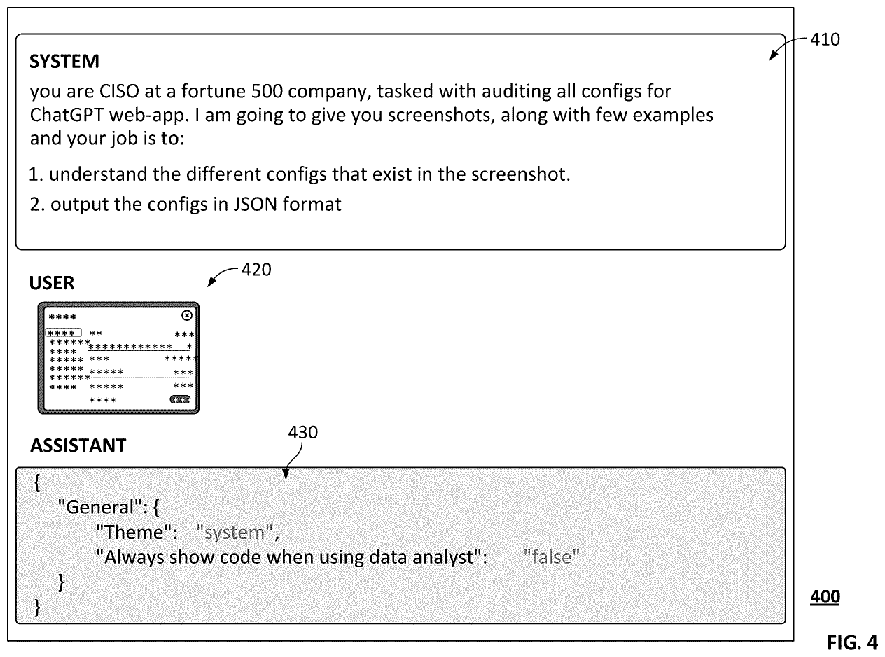

FIG. 4 is an example of a prompt for fine-tuning a configuration detector to perform detections with respect to software-as-a-service (SaaS) application configuration settings according to various embodiments.

According to various embodiments, the system trains or fine tunes a machine learning model, such as an LLM, to detect and classification SaaS application configurations and to detect/control the configuration settings. Training or fine-tuning an LLM to automatically detect and classify SaaS application configurations can include creating a comprehensive training set comprising screenshots of settings pages from a wide range of SaaS applications. These screenshots serve as the foundational dataset, allowing the model to learn how different applications present configuration settings, including variations in layout, text style, and control types. To enhance the model's accuracy, each screenshot is labeled with key attributes, including the setting name, its current value (e.g., enabled/disabled, on/off, or dropdown selection, selected/unselected, etc.), and its corresponding control identifier. This dataset is then used to train the model (or to configure the LLM context) to recognize and extract structured configuration data from previously unseen SaaS application settings pages.

The training process begins by the system applying optical character recognition (OCR) to extract text-based configuration elements from the screenshots. The extracted text is then paired with visual features, such as the position of toggle switches, dropdown menus, and checkboxes, to help the model understand how settings are represented across different SaaS platforms. This is particularly useful for detecting non-textual indicators of configuration states, such as an active toggle switch appearing in a different color or a pre-selected dropdown value. By leveraging a combination of text-based and visual data, the model is trained to generalize across different user interface (UI) designs, allowing the system (e.g., the model) to identify configurations even when the font, language, or structure varies.

In some embodiments, the system implements a visual LLM specifically trained to interpret the context of a settings page. Unlike traditional models that rely solely on text, a visual LLM processes entire images, using deep learning techniques to extract meaningful insights from the layout, graphical elements, and semantic relationships within the page. This allows the model to develop an intrinsic understanding of how different sections of a settings page are structured, enabling it to recognize settings that might not be explicitly labeled in text. For example, the model can infer that a grouping of controls under a “Security” header relates to authentication or access policies, even if the individual settings have generic or ambiguous labels.

In some embodiments, the visual LLM implemented to interpret the context of a settings page is further enhanced through multimodal training, combining textual data from documentation and policies with visual patterns learned from settings page screenshots. This approach enables the model to build a rich contextual understanding of SaaS application configurations, making the visual LLM more resilient to UI variations. The model (e.g., the visual LLM) can also use its intrinsic knowledge to infer missing information. For instance, if a settings page lacks explicit labels for toggle switches but follows a common UI convention, the model can predict the likely function of each switch based on its position and surrounding elements.

Additionally, the system can fine-tune the model (e.g., the LLM, the visual LLM, etc.). Fine-tuning the model includes continuous learning, where new screenshots from updated SaaS applications are periodically added to the training dataset. This enables the model (e.g., the LLM) to stay current with changes in UI design and newly introduced configuration options. Over time, the model develops a highly accurate representation of SaaS configuration settings, reducing the need for manual intervention and improving the reliability of automated audits and policy enforcement.

According to various embodiments, by leveraging a fine-tuned visual LLM, the system provides a scalable and adaptable solution for managing SaaS configurations. Instead of relying on brittle rule-based scrapers, the system implements a model that dynamically interprets settings pages, accurately identifies configuration states, and enforces compliance policies in real time. This results in a more efficient, intelligent, and robust approach to monitoring and securing SaaS application configurations across an organization's digital infrastructure.

Returning to the example shown, prompt 400 comprises prompt context 410 and screenshot 420. The system (e.g., a user) inputs the prompt context 410, such as instructing the model (e.g., the LLM) to analyze input screenshots to understand different configurations that exist and to generate an output (e.g., in JavaScript Object Notation (JSON) format) that specifies the configurations identified by the model. After establishing the context for the model, screenshot 420 is input/provided to the model (e.g., the LLM) for classification. Screenshot 420 may be an image of a SaaS application configuration settings page. In some embodiments, prompt 400 may further include a syntax according to which the model is to output the identified settings/settings page classification(s). Prompt 400 further includes output 430 comprising the identified settings/settings page classification(s) formatted/configured in a predefined format.

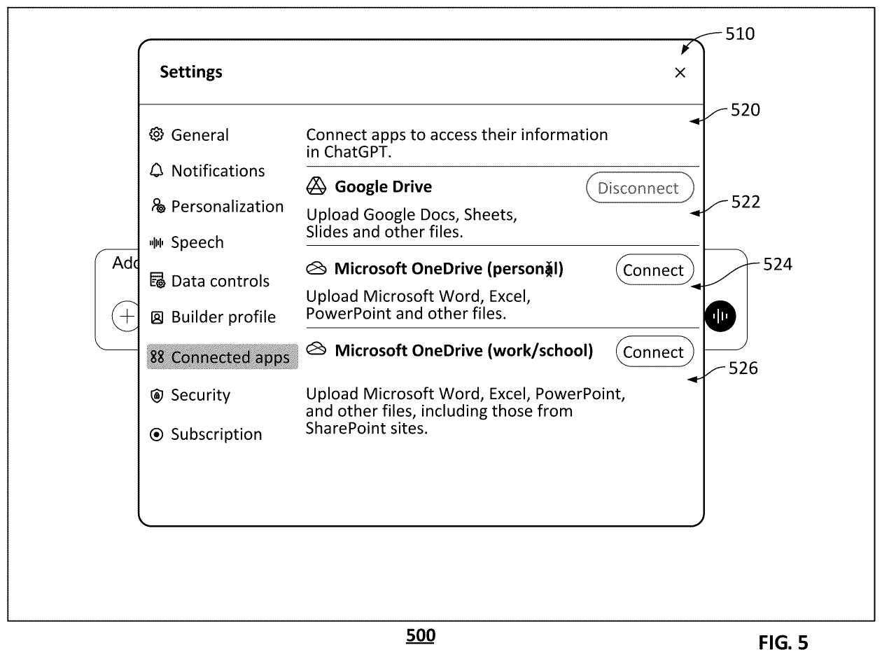

FIG. 5 is an example of a screenshot of a configuration settings page for a SaaS application. As shown, the user interface in screenshot 500 comprises controls via which a user can control connection of applications (e.g., cloud storage services/applications) to the SaaS application being monitored (e.g., ChatGPT). The system can identify the controls for changing the SaaS application configuration settings (e.g., the connection of third party applications) and monitor input to the user interface to change/interact with the controls for changing the SaaS application configuration settings. Screenshot 500 comprises a user interface 510 for a configuration settings page. As shown, the configuration settings page user interface 510 comprises configuration setting 520 for connecting another application or data store with the SaaS application. For example, configuration setting 520 comprises a plurality of controls for such configuration, including control 522 to connect a Google Drive account or datastore to the SaaS application; control 524 to connect a personal Microsoft One Drive account or datastore; and control 526 to connect an organization specific personal Microsoft One Drive account or datastore (e.g., to connect a work or school account).

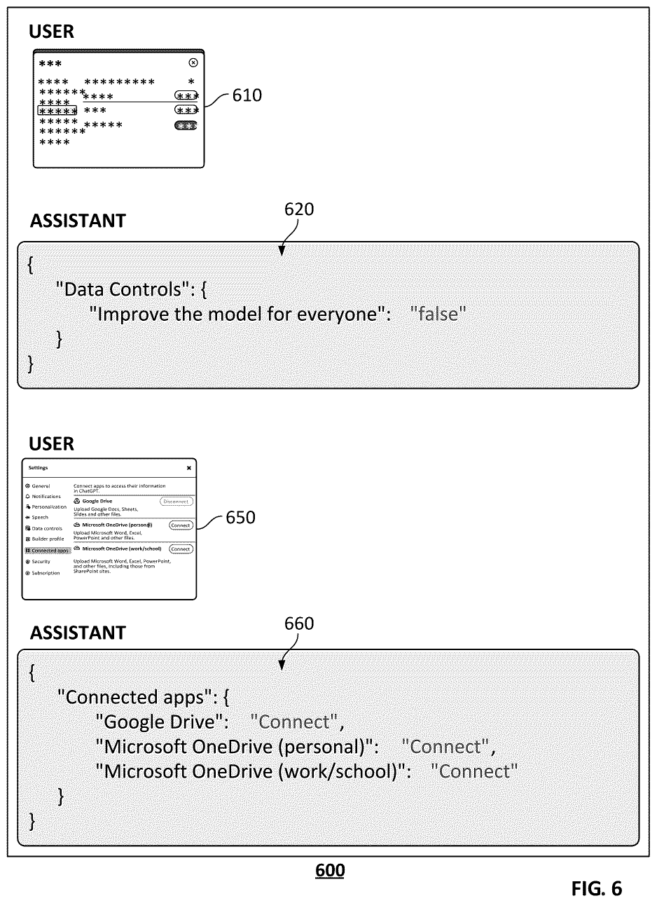

FIG. 6 is an example of prompts for querying a configuration detector to perform detections with respect to SaaS application configuration settings according to various embodiments. Screenshot 610 can be provided to the model as an input for classification. In response to classifying/analyzing screenshot 610, the model (e.g., the LLM) can generate and provide output 620 comprising the identified settings/settings page classification(s) formatted/configured in a predefined format. Similarly, screenshot 650 can be provided to the model as an input for classification. In response to classifying/analyzing screenshot 610, the model (e.g., the LLM) can generate and provide output 660 comprising the identified settings/settings page classification(s) formatted/configured in a predefined format. In the example shown, output 660 comprises an indication that configuration settings include whether third party storage services/drives are connected, the corresponding values for the settings.

FIG. 7 is a block diagram of a system for configuration detector for in connection with a security policy enforcement according to various embodiments. According to various embodiments, system 700 is implemented at least in part by one or more of system 100 of FIG. 1. In some embodiments, system 700 implements at least part of one or more of processes 800-1600 of FIGS. 8-16.

According to various embodiments, system 700 is implemented to classify configuration settings for a SaaS application, monitor attempts to change configuration settings for the SaaS application, and enforce one or more policies with respect to changes to the configuration settings.

In the example shown, system 700 comprises SaaS application input service 710. SaaS application input service 710 identifies a SaaS application to be onboarded or updated, for example, a SaaS for which configuration settings are to be classified/identified and monitored. For example, SaaS applications can be identified based on a user input or a predefined list of SaaS applications such as a list of an organization's deployed SaaS applications. In response to identifying a SaaS application to be for which configuration settings are to be classified/identified SaaS application input service 710 catalogs all URLs (e.g., webpages) associated with the SaaS application.

System 700 further comprises a SaaS application crawling service 720. SaaS application crawling service 720 is implemented to visit a set of URLs for a particular SaaS application being onboarded (or for which the configuration settings classifications is being updated). For example, SaaS application crawling service 720 visits all webpages associated with the particular SaaS application and crawls those webpages to capture information. In some embodiments, SaaS application crawling service 720 crawls the webpages for a particular SaaS application and captures a screenshot for the webpage. SaaS application crawling service 720 may additionally capture/obtain metadata for the crawled webpages, for example, to supplement the classification of the webpage screenshot. In some embodiments, SaaS application crawling service 720 can pre-process the webpage screenshot and/or supplemental information (e.g., SaaS application documentation, webpage metadata, etc.) and generate a document object model (DOM) representation for the webpage. SaaS application crawling service 720 can pre-process the DOM representation, for example, to reduce the size of the representation by eliminating non-relevant information, etc.

In response to obtaining the SaaS application configuration setting information, including the webpage screenshot and, optionally, additional supplemental information (e.g., webpage metadata and/or supporting SaaS application documentation, which may include SaaS vendor-provided documentation, etc.), system 700 (e.g., SaaS application crawling service 720) can provide the SaaS application configuration setting information to a model (e.g., an LLM such as a visual LLM) to classify the SaaS application configuration settings, such as to identify relevant configurations. As an example, system 700 queries the LLM to identify SaaS application configuration settings based at least in part on SaaS application configuration setting information.

System 700 further comprises configuration detector 730. System 700 uses configuration detector 730 to detect configurations for the SaaS application, such as configurations identified on the webpage screenshots for the SaaS application. In some embodiments, configuration detector 730 detects configuration settings (e.g., including the controls for setting the configuration setting values such as whether the setting is controlled by a dropdown menu, a dialog button, etc.), detects configuration setting values, and determines a corresponding text field that is used to search for relevant/corresponding information in the DOM.

System 700 further comprises DOM analyzer 740. DOM analyzer 740 processes the DOM(s) generated for a SaaS application to reduce the amount of information used for querying the model for configuration setting classification/identification (e.g., because querying the model can be expensive). In some embodiments, DOM analyzer 740 reduces screenshot information for a screenshot. System 700 uses this reduced screenshot information in connection with querying the model (e.g., an LLM) to identify specific tags or configurations to be controlled within the SaaS application webpage.

System 700 further comprises LLM module 750. LLM module 750 may implement one or more models, such as models that are specifically trained for analyzing SaaS application webpages, or integrations with generic third party LLMs. LLM module 750 stores (e.g., in a training set) screenshot examples and associated attributes, for example, configuration setting control information (e.g., identified controls, control identifiers, control values, etc.). LLM module 750 can fine-tune the model(s) (e.g., the LLM) based on the training set. The model(s) can then be used in connection with enforcing policies with respect to SaaS application configuration setting changes.

System 700 may further comprise client system 760. Client system 760 is used by a user to navigate to a SaaS application. In some embodiments, system 700 monitors the client system's (e.g., the user's) interaction with the SaaS application, and in particular with respect to interactions with webpages for the SaaS application configuration settings. The policies may be enforced by client software running at client system 760 (e.g., a web browser extension or a protected browser, etc.) or by a cloud security service via which client system's 760 access to the SaaS application is mediated. In the example, shown, client system 760 comprises web browser 765. Web browser 765 may implement a protected browser or an extension in connection with policy enforcement.

In some embodiments, traffic with respect to the SaaS application is monitored via web browser 765 or a corresponding service implemented at a cloud security service that mediates traffic between web browser 765. For example, system 700 (e.g., web browser 765 or the cloud security service) can dynamically retrieve attributes (e.g., by configuration settings monitoring service 767) for the SaaS application on load of a webpage. As an illustrative example, as each webpage for the SaaS application is loaded, system 700 can determine whether the webpage corresponds to a configuration settings page (e.g., a page via which configuration settings can be controlled). System 700 (e.g., policy enforcement service 769) can enforce a policy based at least in part on the webpage being navigated or with which the user is interacting. For example, in response to determining that a webpage being navigated corresponds to a configuration settings page, system 700 enforces a policy by monitoring user interaction with the webpage to determine whether the user interaction (e.g., user input) corresponds to an attempt to change a configuration setting (or specifically a configuration setting associated with an enforced policy(ies)). System 700 can monitor the user interaction by intercepting commands/inputs before they are passed along to the SaaS application/service. In response to obtaining a user interaction (e.g., a user input/command), system 700 can enforce one or more policies with respect to the user interaction. For example, if the user interaction is determined to result in a policy violation, system 700 can restrict such user interaction such as by dropping the user input/command (e.g., not passing the command/request) to the SaaS application.

FIG. 8 is a flow diagram of a method for enforcing a policy with respect to SaaS application configuration settings according to various embodiments. According to various embodiments, process 800 is implemented at least in part by one or more of system 100 of FIG. 1, system 200 of FIG. 2, system 300 of FIG. 3, and/or system 700 of FIG. 7. In some embodiments, process 800 is implemented by a network security service, such as security platform 140 of system 100, or a service running on a client system, etc.

At 805, the system automatically onboards a software-as-a-service (SaaS) application for an enterprise by determining a set of application settings for the SaaS application based on a screenshot of a settings page for the SaaS application using a machine learning model. At 810, the system uses a machine learning model (e.g., an LLM) to monitor for an attempt to change the application settings (e.g., the SaaS application configuration settings). At 815, the system enforces a policy based at least in part on the monitoring for the attempt to change the application settings. At 820, the system determines whether process 800 is complete. In some embodiments, the system determines process 800 to be complete in response to a determination that no further configuration setting changes are to be evaluated, no further security policies are to be enforced, no further SaaS applications are to be monitored, no further user interaction with SaaS applications are to be monitored, a session (e.g., with a SaaS application) has ended, an administrator indicates that process 800 is to be paused or stopped, etc. In response to a determination that process 800 is complete, process 800 ends. In response to a determination that process 800 is not complete, process 800 returns to 805.

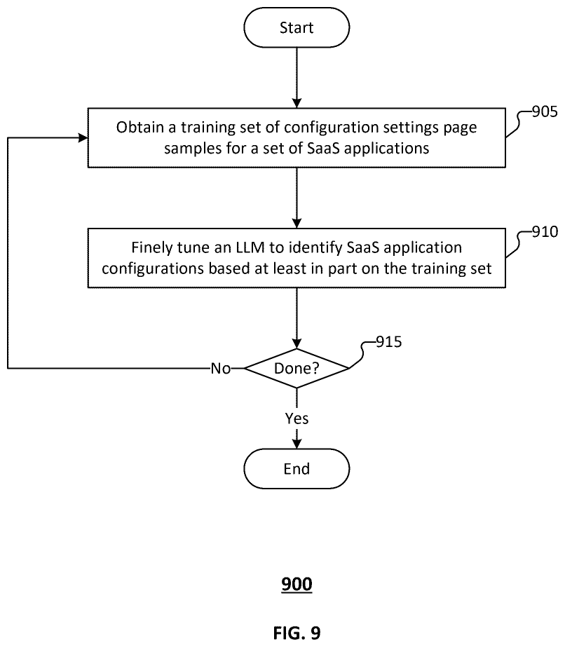

FIG. 9 is a flow diagram of a method for training a configuration detector to perform detections with respect to SaaS application configuration settings according to various embodiments. According to various embodiments, process 900 is implemented at least in part by one or more of system 100 of FIG. 1, system 200 of FIG. 2, system 300 of FIG. 3, and/or system 700 of FIG. 7. In some embodiments, process 900 is implemented by a network security service, such as security platform 140 of system 100, or a service running on a client system, etc.

At 905, the system obtains a training set of configuration settings page samples for a set of SaaS applications. At 910, the system finely tunes an LLM to identify SaaS application configurations based at least in part on the training set. At 915, the system determines whether process 900 is complete. In some embodiments, the system determines process 900 to be complete in response to a determination that no further SaaS applications are to be onboarded, no further updates/refinements are to be made to the LLM or configuration setting detector, an administrator indicates that process 900 is to be paused or stopped, etc. In response to a determination that process 900 is complete, process 900 ends. In response to a determination that process 900 is not complete, process 900 returns to 905.

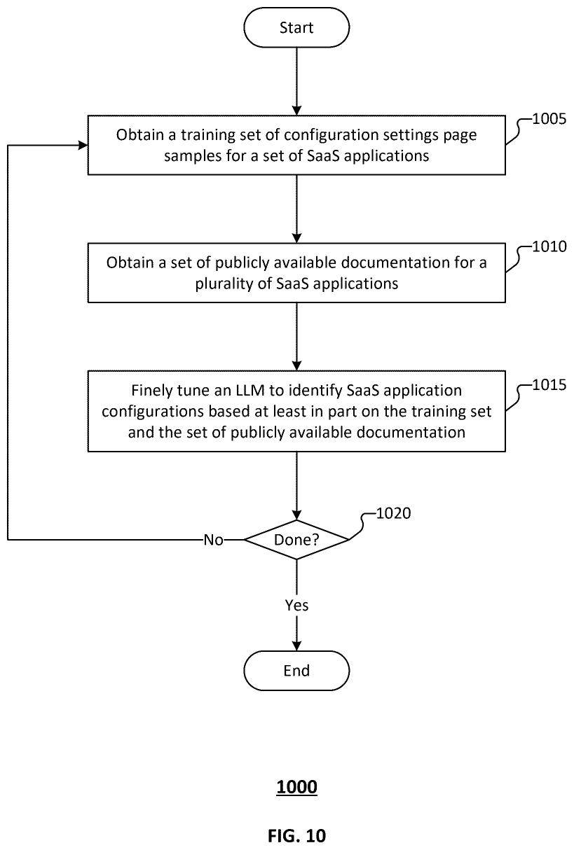

FIG. 10 is a flow diagram of a method for training a configuration detector to perform detections with respect to SaaS application configuration settings according to various embodiments. According to various embodiments, process 1000 is implemented at least in part by one or more of system 100 of FIG. 1, system 200 of FIG. 2, system 300 of FIG. 3, and/or system 700 of FIG. 7. In some embodiments, process 1000 is implemented by a network security service, such as security platform 140 of system 100, or a service running on a client system, etc.

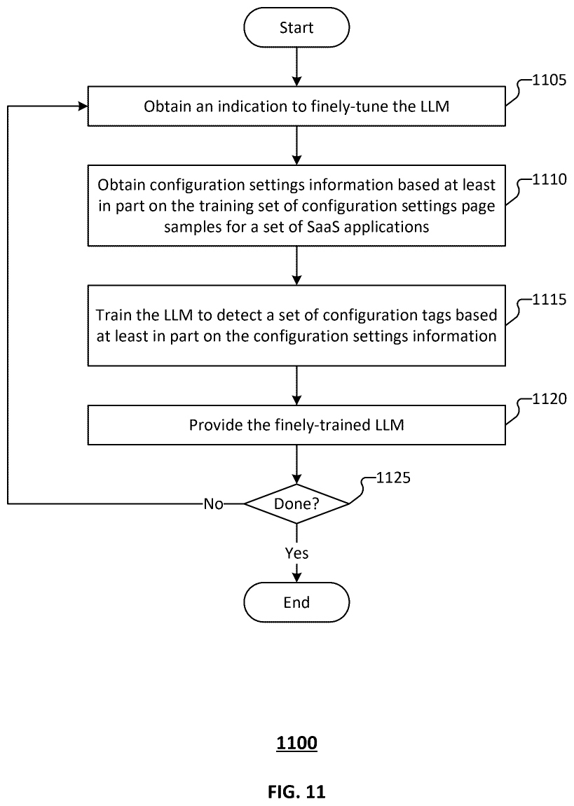

At 1005, the system obtains a training set of configuration settings page samples for a set of SaaS applications. At 1010, the system obtains a set of publicly available documentation for a plurality of SaaS applications. At 1015, the system finely tunes an LLM to identify SaaS application configurations based at least in part on the training set and the set of publicly available documentation. For example, the system invokes process 1100 of FIG. 11. At 1020, the system determines whether process 1000 is complete. In some embodiments, the system determines process 1000 to be complete in response to a determination that no further SaaS applications are to be onboarded, no further updates/refinements are to be made to the LLM or configuration setting detector, an administrator indicates that process 1000 is to be paused or stopped, etc. In response to a determination that process 1000 is complete, process 1000 ends. In response to a determination that process 1000 is not complete, process 1000 returns to 1005.

FIG. 11 is a flow diagram of a method for fine-tuning a configuration detector to perform detections with respect to SaaS application configuration settings according to various embodiments. According to various embodiments, process 1100 is implemented at least in part by one or more of system 100 of FIG. 1, system 200 of FIG. 2, system 300 of FIG. 3, and/or system 700 of FIG. 7. In some embodiments, process 1100 is implemented by a network security service, such as security platform 140 of system 100, or a service running on a client system, etc. In some embodiments, process 1100 is invoked by process 900, such as at 910. In some embodiments, process 1100 is invoked by process 1000, such as at 1015.

Fine-tuning and training a machine learning model (e.g., the LLM) to detect and classify SaaS application configurations is further augmented using publicly available documentation, which provides an additional layer of accuracy and adaptability. Many SaaS providers publish detailed documentation outlining the available configuration options, their descriptions, and their potential values. This documentation serves as a valuable supplement to the training dataset, helping the model understand configurations that may not be explicitly visible on a given settings page or may require additional context to interpret correctly.

During the fine-tuning process, the model is trained on a dataset that includes both visual data (e.g., screenshots of settings pages) and textual data extracted from official SaaS documentation, user manuals, and API references. By combining these sources, the LLM gains a more comprehensive understanding of how configurations are structured, their intended functions, and their acceptable value ranges. For example, while a settings page may display a toggle labeled “Enable Security Logs,” the corresponding documentation may clarify what specific logs are recorded, how long they are retained, and how enabling or disabling this option affects compliance with security policies. Incorporating this information into the training process enables the model to classify configurations with greater accuracy and reliability.

In some embodiments, the classification performed by the LLM is directly augmented in real-time using publicly available documentation. When the model encounters an unfamiliar configuration or a setting that lacks clear textual context, it can query external documentation sources to retrieve relevant information. This dynamic augmentation allows the system to interpret newly introduced settings without requiring retraining. For example, if a SaaS provider releases a new configuration option, the model can analyze the related documentation to determine its function and expected values, enabling it to classify the setting correctly without human intervention.

Additionally, the model can leverage natural language processing (NLP) techniques to align extracted configurations with their corresponding descriptions from the documentation. This helps in cases where different SaaS applications use inconsistent terminology for similar settings. For instance, one application may label a setting as “Two-Factor Authentication,” while another refers to it as “Multi-Factor Authentication.” By cross-referencing these terms with documentation, the model can standardize its classification, ensuring consistent identification across different SaaS platforms.

Another advantage of integrating supplemental and/or publicly available documentation is improved handling of UI variations. SaaS applications frequently update their interfaces, introducing changes that may affect how configurations are displayed. Because documentation updates often accompany these changes, using documentation as a secondary reference ensures that the model remains accurate even when visual elements are modified. This reduces the risk of false positives or negatives that may arise due to unexpected UI changes, making the classification process more robust.

Returning to the example shown, at 1105, the system obtains an indication to finely-tune the LLM. At 1110, the system obtains configuration settings information based at least in part on the training set of configuration settings page samples for a set of SaaS applications. At 1115, the system trains the LLM to detect a set of configuration tags based at least in part on the configuration settings information. For example, the system trains the LLM to associate certain configuration setting controls with configurations settings to be monitored. At 1120, the system provides the finely-trained LLM. At 1125, the system determines whether process 1100 is complete. In some embodiments, the system determines process 1100 to be complete in response to a determination that no further SaaS applications are to be onboarded, no further updates/refinements are to be made to the LLM or configuration setting detector, an administrator indicates that process 1100 is to be paused or stopped, etc. In response to a determination that process 1100 is complete, process 1100 ends. In response to a determination that process 1100 is not complete, process 1100 returns to 1105.

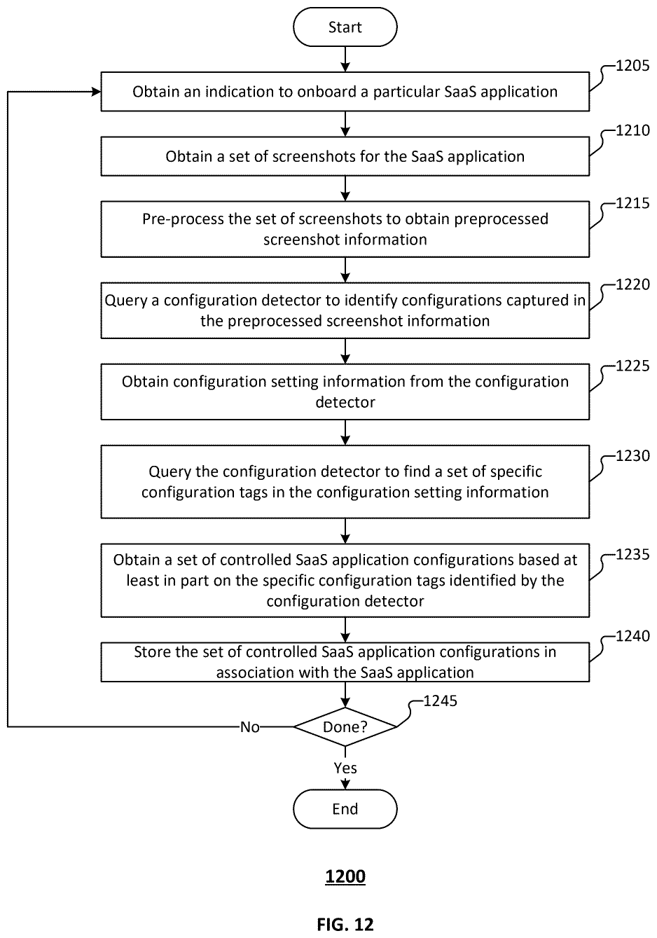

FIG. 12 is a flow diagram of a method for onboarding a particular SaaS application according to various embodiments. According to various embodiments, process 1200 is implemented at least in part by one or more of system 100 of FIG. 1, system 200 of FIG. 2, system 300 of FIG. 3, and/or system 700 of FIG. 7. In some embodiments, process 1200 is implemented by a network security service, such as security platform 140 of system 100.

According to various embodiments, the system for onboarding a SaaS application is designed to automatically detect and classify application configurations, streamlining the process of managing security and compliance settings. Upon receiving a request to onboard a new SaaS application, the system initiates an automated traversal of the SaaS application's user interface to identify relevant configuration settings. In some embodiments, the system automatically traverses user interface(s) for the various pages of the SaaS application (e.g., the pages hyperlinked to via the SaaS application). This automated process eliminates the need for manual discovery and ensures comprehensive coverage of all configurable elements within the application.

As part of the onboarding process, the system systematically navigates through the various pages of the SaaS application. It does this by identifying and clicking on all available links on each page, progressing through the application's interface in a structured manner. For each visited page, the system captures a screenshot or extracts relevant information and then queries an LLM to classify the page. The LLM evaluates the page's context to determine whether it contains configuration settings or elements that allow users to modify application behaviors. If a page is identified as a settings page, the system proceeds with further analysis to detect and classify its configuration options.

In some embodiments, to improve the accuracy of classification, the system utilizes the LLM to extract meaningful information from each settings page. The LLM analyzes textual and visual elements of the page to identify configuration options, determine their corresponding values (such as enabled/disabled toggles, dropdown selections, or checkboxes, etc.), and map them to standardized control identifiers. Because different SaaS applications use varying terminology for similar configurations, the system normalizes these differences by mapping synonymous terms to a common control identifier. For example, some applications refer to multi-factor authentication as “MFA,” while others use “2FA” or “Multi-Factor Authentication.” The system (e.g., via the LLM) recognizes these variations and consolidates them under a single control identifier for consistency.

According to various embodiments, in cases where the system encounters a configuration setting that does not match any predefined control identifier, the system generates a new control identifier and flags the setting for further analysis (e.g., the system can prompt an administrator or other subject matter export for review). This ensures that the system can adapt to new or evolving SaaS applications that introduce novel configuration options. The flagged configurations are marked as predicted or unverified, signaling that they require additional validation. In some embodiments, to refine the classification process, the system may compare the flagged configurations against similar settings detected in other SaaS applications or correlate them with publicly available documentation.

For settings that require deeper analysis, the system can escalate the flagged configurations for manual review by domain experts. These experts can assess the newly detected settings and determine whether they should be assigned to an existing control identifier or defined as a new configuration category. This human-in-the-loop approach ensures that the system remains accurate and up to date while minimizing false classifications. Over time, as more SaaS applications are onboarded and analyzed, the system continuously improves its ability to recognize and categorize configurations with minimal manual intervention. For example, the system can be retrained based on these newly detected configuration settings (e.g., the context for the LLM may be refined based on the detected new configuration settings and/or detected classifications).

By leveraging an LLM-driven approach to SaaS application onboarding, the system provides a scalable and intelligent solution for detecting, classifying, and normalizing configuration settings across diverse applications. The automated traversal process ensures thorough coverage of all available settings, while the use of control identifiers enhances consistency across different SaaS platforms. The ability to flag and refine unknown configurations allows the system to remain adaptive, ensuring that new and evolving SaaS applications can be seamlessly integrated into an organization's security and compliance framework.

According to various embodiment, the system ensures that onboarded SaaS applications remain up to date by periodically traversing their settings pages or initiating updates in response to specific triggers. Because that SaaS applications frequently undergo changes, such as modifications to their user interface, the introduction of new configuration settings, or the restructuring of menus, the system must continuously monitor and adapt to these changes. By doing so, the system maintains accurate mappings of configuration settings, ensuring that security and compliance policies remain enforceable.

To achieve this, the system periodically navigates through the SaaS application's pages using an automated traversal mechanism. Similar to the initial onboarding process, the system identifies and follows links across the application's interface, systematically analyzing each visited page to detect the presence of configuration settings. As the system traverses the application, the system captures new screenshots or extracts textual data, which are then analyzed using an LLM to determine whether any changes have occurred. If the system (e.g., the LLM) identifies differences in the structure or content of the settings pages compared to previously stored mappings, the system updates its database accordingly.

In addition to periodic updates, the system can initiate a re-evaluation of an onboarded SaaS application in response to specific triggers. Triggers can include detected anomalies, administrator requests, or external signals such as API updates or release notes from the SaaS provider indicating a change in the application's configuration options. For example, if a user attempts to access a known settings page and the system detects that the expected configuration elements are missing or have been relocated, the system can trigger a full re-traversal of the application to identify and map the new settings structure. This ensures that any modifications to the application's user interface or settings organization are promptly accounted for.

When changes are detected, the system updates the stored configuration mappings for the particular SaaS application. Each detected setting is reclassified and, if necessary, re-mapped to the appropriate control identifier. If new settings are introduced that do not match any existing identifiers, the system can generate new control identifiers and flag them for further analysis. This allows the system to adapt dynamically to evolving SaaS platforms without requiring manual intervention for every update. Administrators can review flagged changes and provide input to refine the mappings, ensuring accuracy and consistency across different applications.

To maintain historical visibility, the system can also version-control its configuration mappings. By storing previous iterations of a SaaS application's settings, the system enables administrators to track how configurations have changed over time. This historical data can be useful for auditing purposes, allowing organizations to analyze past changes, identify trends, and assess the impact of application updates on security and compliance policies.

Returning to the example shown, at 1205, the system obtains an indication to onboard a particular SaaS application. At 1210, the system obtains a set of screenshots for the SaaS application. At 1215, the system pre-processes the set of screenshots to obtain preprocessed screenshot information. At 1220, the system queries a configuration detector to identify configurations captured in the preprocessed screenshot information. At 1225, the system obtains configuration setting information from the configuration detector. At 1230, the system queries the configuration detector to find a set of specific configuration tags in the configuration setting information. At 1235, the system obtains a set of controlled SaaS application configurations based at least in part on the specific configuration tags identified by the configuration detector. At 1240, the system stores the set of controlled SaaS application configurations in association with the SaaS application. At 1245, the system determines whether process 1200 is complete. In some embodiments, the system determines process 1200 to be complete in response to a determination that no further SaaS applications are to be onboarded, no further SaaS application configuration setting controls are to be monitored, no further user inputs are to be monitored/evaluated, an administrator indicates that process 1200 is to be paused or stopped, etc. In response to a determination that process 1200 is complete, process 1200 ends. In response to a determination that process 1200 is not complete, process 1200 returns to 1205.

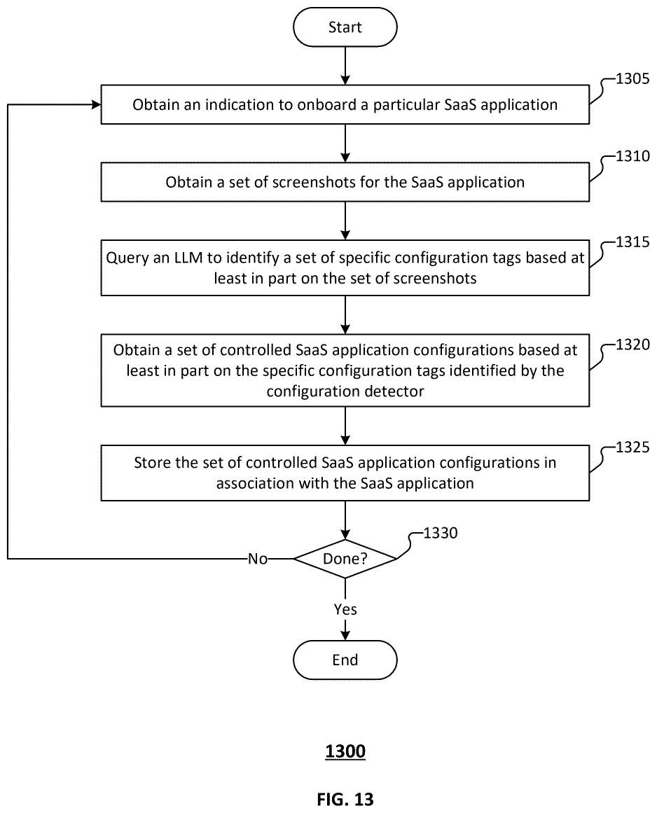

FIG. 13 is a flow diagram of a method for onboarding a particular SaaS application according to various embodiments. According to various embodiments, process 1300 is implemented at least in part by one or more of system 100 of FIG. 1, system 200 of FIG. 2, system 300 of FIG. 3, and/or system 700 of FIG. 7. In some embodiments, process 1300 is implemented by a network security service, such as security platform 140 of system 100.

At 1305, the system obtains an indication to onboard a particular SaaS application. At 1310, the system obtains a set of screenshots for the SaaS application. At 1315, the system queries an LLM (or other AI service) to identify a set of specific configuration tags based at least in part on the set of screenshots. At 1320, the system obtains a set of controlled SaaS application configurations based at least in part on the specification configuration tags identified by the configuration detector. At 1325, the system stores the set of controlled SaaS application configurations in association with the SaaS application. At 1330, the system determines whether process 1300 is complete. In some embodiments, the system determines process 1300 to be complete in response to a determination that no further SaaS applications are to be onboarded, no further SaaS application configuration setting controls are to be monitored, an administrator indicates that process 1300 is to be paused or stopped, etc. In response to a determination that process 1300 is complete, process 1300 ends. In response to a determination that process 1300 is not complete, process 1300 returns to 1305.

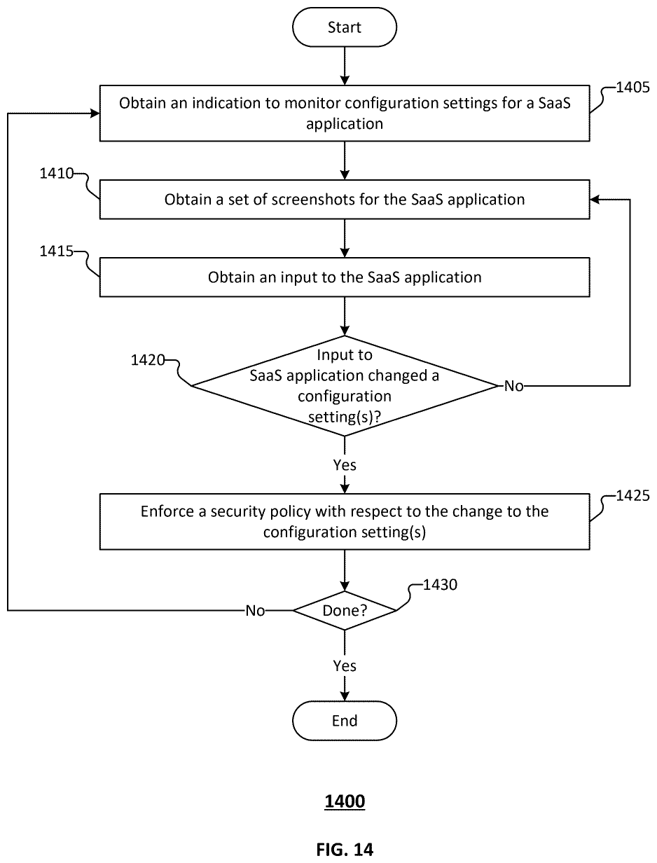

FIG. 14 is a flow diagram of a method for monitoring configuration settings for a particular SaaS application according to various embodiments. According to various embodiments, process 1400 is implemented at least in part by one or more of system 100 of FIG. 1, system 200 of FIG. 2, and/or system 700 of FIG. 7. In some embodiments, process 1400 is implemented by a network security service, such as security platform 140 of system 100. In some embodiments, process 1400 is implemented at a client system, such as in a security service enforced for a web browser running at the client system.

Monitoring SaaS application configuration settings is crucial for ensuring compliance with security policies and preventing unauthorized or unintended changes. The system continuously monitors user interactions with SaaS applications (e.g., the system monitors the user interactions in real time), particularly focusing on settings pages where configurations can be modified. By analyzing these interactions in real time, the system can detect changes, classify them based on policy requirements, and take appropriate actions to enforce compliance.

In some embodiments, the system captures periodic or event-driven screenshots of SaaS application settings pages as they are accessed in a web browser. These screenshots are then processed using a large language model (LLM) trained to recognize and classify configuration settings pages. The LLM analyzes the screenshots to determine whether they contain configuration settings and, if so, identifies the specific configurations and their corresponding values. This classification process enables the system to differentiate between general SaaS application pages (such as dashboards or user interfaces) and settings pages where configurations can be modified. If the system detects that a user is viewing or interacting with a settings page, it can further analyze the page to extract one or more of the settings' names, types, category, and values. The system can further determine whether the configuration settings are compliant with predefined policies.

In some embodiments, the system is implemented as a browser extension installed on the user's device (e.g., at the client system). This extension operates within the browser, monitoring user interactions with SaaS applications in real time. When a user navigates to a settings page, the browser extension can automatically capture relevant screenshots and metadata, such as the URL and page structure. The captured data is then analyzed by the LLM (e.g., either locally or by a cloud service queried by the client system) to classify the configurations (e.g., the configuration settings) and their values. If the system detects an attempted configuration change, it can compare the new settings with compliance policies and issue alerts or prevent non-compliant changes before they take effect. This approach ensures that policy enforcement occurs at the point of interaction, reducing the risk of misconfigurations slipping through unnoticed.

Alternatively, the system can be integrated into a secure browser that provides built-in monitoring and enforcement capabilities. Unlike a browser extension (e.g., which can operate as an add-on to a standard browser), a secure browser can be designed specifically for enterprise security and policy enforcement. The secure browser can log all interactions with SaaS application settings pages, capturing both screenshots and structured data for analysis. Because it is a controlled environment, the secure browser can enforce stricter security measures, such as preventing users from saving non-compliant configuration changes or requiring administrative approval for certain modifications. This implementation is particularly useful for organizations with strict compliance requirements that need to maintain tight control over SaaS application configurations.

The system can also implement real-time detection of configuration changes by continuously monitoring DOM elements in the browser. By analyzing changes to the structure of the settings page, the system can detect when a user modifies a configuration setting, even before they attempt to save it (or in response to the attempt to save it but before the corresponding request is sent to the SaaS application or other backend cloud service). This allows for proactive intervention, such as displaying a warning message if a user is about to enable an insecure setting or disable an essential security feature. If the system identifies an attempted policy violation, it can automatically take corrective actions, such as reverting the change, blocking the action (e.g., dropping the corresponding web request), and/or notifying an administrator for review.

In some implementations, the monitoring process is augmented with historical data to track configuration changes over time. The system can maintain a record of all detected settings and their modifications, allowing administrators to audit changes, identify trends, and detect potential security risks. This historical analysis can also be used to refine the LLM's classification capabilities, improving its ability to recognize and interpret new or updated settings pages.

According to various embodiments, by leveraging a browser extension or a secure browser, the system provides a comprehensive and scalable approach to monitoring SaaS application configurations. It ensures that changes are detected and classified accurately (and promptly or in real time), allowing organizations to enforce compliance policies effectively while minimizing the risk of misconfigurations.

Returning to the example shown, at 1405, the system obtains an indication to monitor configuration settings for a SaaS application. At 1410, the system obtains a set of screenshots for the SaaS application. At 1415, the system obtains an input to the SaaS application. At 1420, the system determines whether the input to the SaaS application changed a configuration setting(s). In response to determining that the input to the SaaS application does not change a configuration setting(s) at 1420, process 1400 returns to 1410 and process iterates over 1400-1420 until the system detects a user input that changes a configuration setting (e.g., a controlled configuration setting) or a user or administrator ends the process, such as a user closing a session with respect to a SaaS application. Conversely, in response to determining that the input to the SaaS application changed a configuration setting(s), process 1400 proceeds to 1425 at which the system enforces a security policy with respect to the change to the configuration setting(s). At 1430, the system determines whether process 1400 is complete. In some embodiments, the system determines process 1400 to be complete in response to a determination that no further configuration setting changes are to be evaluated, no further SaaS application configurations are to be monitored, a session (e.g., with a SaaS application) has ended, no further user inputs are to be monitored/evaluated, an administrator indicates that process 1400 is to be paused or stopped, etc. In response to a determination that process 1400 is complete, process 1400 ends. In response to a determination that process 1400 is not complete, process 1400 returns to 1405.

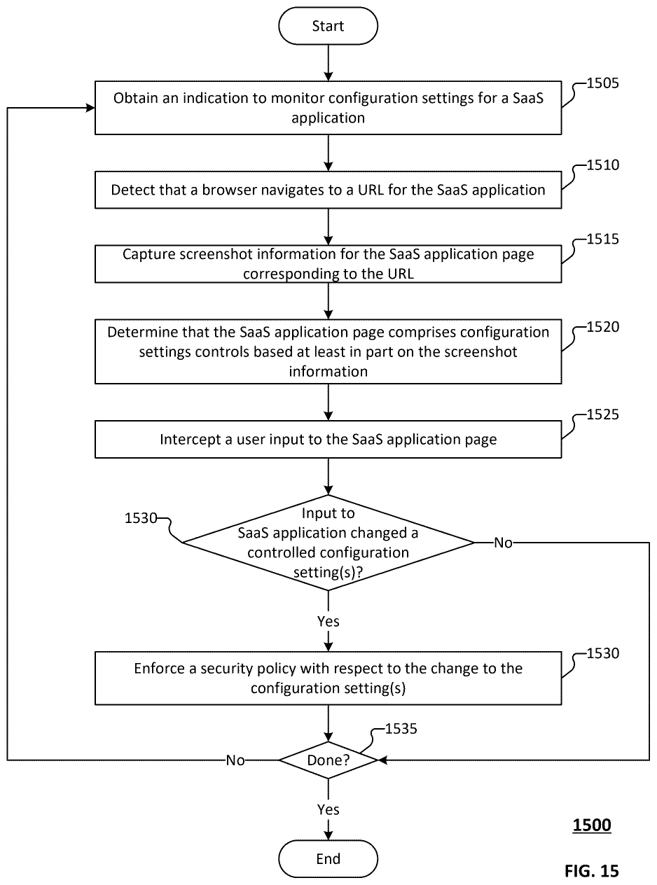

FIG. 15 is a flow diagram of a method for monitoring configuration settings for a particular SaaS application according to various embodiments. According to various embodiments, process 1500 is implemented at least in part by one or more of system 100 of FIG. 1, system 200 of FIG. 2, and/or system 700 of FIG. 7. In some embodiments, process 1500 is implemented at a client system, such as in a security service enforced for a web browser running at the client system.

At 1505, the system obtains an indication to monitor configuration settings for a SaaS application. At 1510, the system detects that a browser navigates to a URL for the SaaS application. At 1515, the system captures screenshot information for the SaaS application page corresponding to the URL. At 1520, the system determines that the SaaS application page comprises configuration settings controls based at least in part on the screenshot information. For example, the system queries an LLM to determine whether the screenshot information corresponds to a SaaS application page comprising configuration settings controls. At 1525, the system intercepts a user input to the SaaS application page. For example, the system intercepts the user input via a secure browser or other enforcement point (e.g., on a client system, a firewall or other security entity, etc.). At 1530, the system determines whether the input to the SaaS application changed a controlled configuration setting(s). In response to determining that the input to the SaaS application changed a controlled configuration setting(s), process 1500 proceeds to 1530 at which the system enforces a security policy with respect to the change to the configuration setting(s). Conversely, in response to determining that the input to the SaaS application did not change a controlled configuration setting(s), process 1500 proceeds to 1535. At 1535, the system determines whether process 1500 is complete. In some embodiments, the system determines process 1500 to be complete in response to a determination that no further configuration setting changes are to be evaluated, no further SaaS application configurations are to be monitored, a session (e.g., with a SaaS application) has ended, no further user inputs are to be monitored/evaluated, an administrator indicates that process 1500 is to be paused or stopped, etc. In response to a determination that process 1500 is complete, process 1500 ends. In response to a determination that process 1500 is not complete, process 1500 returns to 1505.

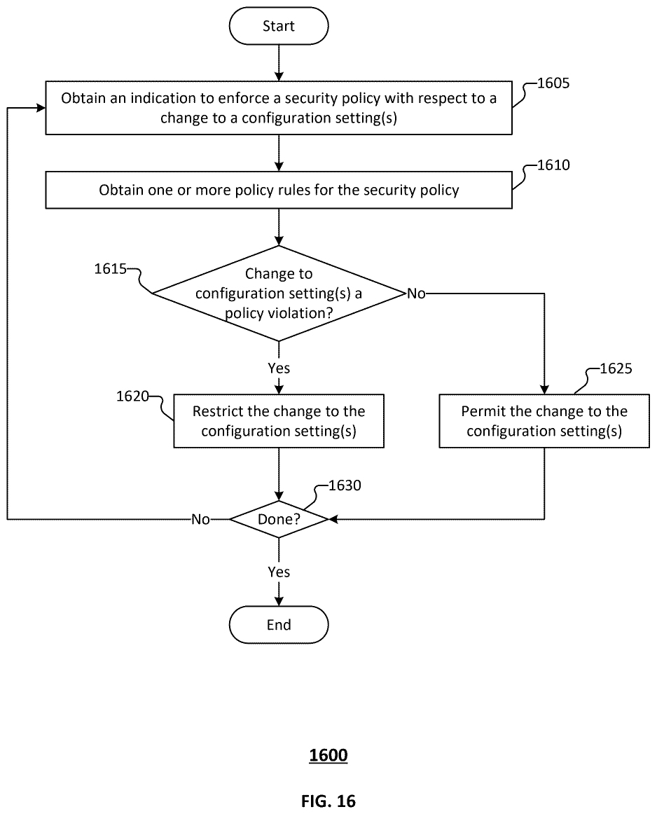

FIG. 16 is a flow diagram of a method for enforcing a policy with respect to a detected change to a SaaS application configuration setting according to various embodiments. According to various embodiments, process 1600 is implemented at least in part by one or more of system 100 of FIG. 1, system 200 of FIG. 2, and/or system 700 of FIG. 7. In some embodiments, process 1600 is implemented by a network security service, such as security platform 140 of system 100. In some embodiments, process 1600 is implemented at a client system, such as in a security service enforced for a web browser running at the client system.

According to various embodiments, the system enforces security and compliance policies by monitoring user interactions with SaaS application settings and preventing unauthorized or non-compliant configuration changes. When a user attempts to modify a configuration, the system analyzes the change in real time to determine whether it aligns with predefined security policies. If the system detects that the change would violate a policy, it can take prompt/immediate action to restrict or prevent the modification, ensuring that critical security and operational settings remain compliant with organizational standards.

In some embodiments, the system intercepts attempted configuration changes and prevents them from being applied. The system can achieve this by detecting modifications at the browser level, either through a browser extension or a secure browser, and dropping the request before the request reaches the SaaS application's backend. For example, if a user attempts to disable multi-factor authentication in a SaaS application that requires it for compliance, the system can block the change, preventing the update from being saved. This enforcement mechanism ensures that security-critical settings cannot be altered in a way that exposes the organization to risks.

In some embodiments, the system provides real time (e.g., immediate) feedback to the user when a policy violation is detected. Instead of simply blocking the change without explanation, the system can generate an in-browser notification informing the user that the attempted modification violates company policies. This approach serves as a form of real-time training, helping users understand security best practices and reducing the likelihood of repeated violations. The message can include context-specific details, such as a brief explanation of the policy or a link to relevant documentation, ensuring that users are educated on why certain configurations must remain unchanged.

In addition to alerting the user, the system can notify administrators when a policy violation attempt is detected. This enables security teams to maintain visibility into potential risks and respond accordingly. For instance, if a user repeatedly tries (e.g., performs a predefined number of attempts) to disable critical security settings, the system can escalate the issue to an administrator, who can then review the situation and take appropriate action. These alerts can be integrated with existing security information and event management (SIEM) systems, allowing organizations to track configuration change attempts as part of their broader security monitoring efforts.

For policies that require a more flexible approach (e.g., policies of a particular type or associated with a particular category), the system can be configured to allow certain changes only after administrative approval. In such cases, when a user attempts to modify a restricted setting, the system can automatically generate a request for review (e.g., the system can prompt an administrator to approve/deny the policy change request). An administrator can then assess the change and either approve or deny it based on the organization's security requirements. This workflow ensures that necessary modifications can be made when justified while still maintaining oversight and control over critical configurations.

By enforcing policies in real time, the system prevents security misconfigurations before they can impact the organization. It ensures that users adhere to established security standards while also providing educational feedback and escalating potential risks to administrators. This proactive approach not only enhances security but also improves compliance by ensuring that SaaS applications are consistently configured in accordance with organizational policies.

Returning to the example shown, at 1605, the system obtains an indication to enforce a security policy with respect to a change to a configuration settings(s). At 1610, the system obtains one or more policy rules for the security policy. At 1615, the system determines whether the change to a configuration setting(s) is a policy violation. In response to determining that the change to a configuration setting(s) is a policy violation at 1615, process 1600 proceeds to 1620 at which the system restricts the change to the configuration setting(s). Conversely, in response to determining that the change to the configuration setting(s) is not a policy violation at 1615, process 1600 proceeds to 1625 at which the system permits the change to the configuration setting(s). At 1630, the system determines whether process 1600 is complete. In some embodiments, the system determines process 1600 to be complete in response to a determination that no further configuration setting changes are to be evaluated, no further security policies are to be enforced, an administrator indicates that process 1600 is to be paused or stopped, etc. In response to a determination that process 1600 is complete, process 1600 ends. In response to a determination that process 1600 is not complete, process 1600 returns to 1605.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
automatically onboard a software-as-a-service (SaaS) application for an enterprise by determining a set of application settings for the SaaS application based on a screenshot of a settings page for the SaaS application using a machine learning model;
perform monitoring, using the machine learning model, for an attempt to change the application settings; and
enforce a policy based at least in part on the monitoring for the attempt to change the application settings; and
a memory coupled to the one or more processors and configured to provide the one or more processors with instructions.

2. The system of claim 1, wherein the machine learning model is a large language model (LLM).

3. The system of claim 1, wherein the machine learning model is a finely tuned large language model (LLM).

4. The system of claim 1, wherein the monitoring for the attempt of change the application settings is implemented by a browser extension for a browser via which a user navigates to settings page for the SaaS application.

5. The system of claim 1, wherein the monitoring for the attempt of change the application settings is implemented by a secure browser via which a user navigates to settings page for the SaaS application.

6. The system of claim 1, wherein the policy comprises a SaaS application configuration settings policy.

7. The system of claim 1, wherein enforcing the policy comprises providing an in-browser user coaching.

8. The system of claim 7, wherein the in-browser user coaching includes providing a prompt indicating that a change to a particular application setting is not permitted by the policy.

9. The system of claim 1, wherein enforcing the policy comprises sending to an administrator an alert that a user has attempted to change the application settings in violation of the policy.

10. The system of claim 1, wherein automatically onboarding the SaaS application comprises performing an optical character recognition (OCR) for the screenshot of the settings page for the SaaS application.

11. The system of claim 1, wherein automatically onboarding the SaaS application comprises performing comprises capturing a screenshot for the screenshot of the settings page for the SaaS application.

12. The system of claim 1, wherein automatically onboarding the SaaS application comprises performing comprises querying the machine learning model for a list of configurations that can be configured on the settings page via a user interface.

13. The system of claim 12, wherein the list of configurations is stored in association with a tenant identifier for the enterprise.

14. The system of claim 12, wherein a particular configuration comprised in the list of configurations is mapped to a control identifier.

15. The system of claim 12, wherein automatically onboarding the SaaS application further comprises:
determining whether a particular configuration matches an existing control identifier; and
in response to determining that the particular configuration does not match an existing control identifier, generating a new control identifier and associating the new control identifier as a predicted control subject to further in-depth analysis.

16. The system of claim 1, wherein performing the monitoring for an attempt to change the application settings comprises:
capturing a screenshot for the settings page for the SaaS application; and
performing a policy scan to evaluate a current configuration of the application settings.

17. The system of claim 16, wherein the performing of the policy scan comprises:
querying the machine learning model to evaluate the current configuration of the application settings, wherein the machine learning model evaluates the application settings and characterizes a particular application setting as a pass or violation with respect to the policy.

18. The system of claim 1, wherein automatically onboarding the SaaS application comprises:
mapping a configuration to a rule; and
storing the mapping of the configuration to the rule, wherein the machine learning model uses the mapping of the configuration to the rule in connection with enforcing the policy.

19. The system of claim 18, wherein the rule comprises one or more of a policy rule and a compliance standard rule.

20. A method, comprising:
automatically onboarding a software-as-a-service (SaaS) application for an enterprise by determining a set of application settings for the SaaS application based on a screenshot of a settings page for the SaaS application using a machine learning model;
performing a monitoring, using the machine learning model, for an attempt to change the application settings; and
enforcing a policy based at least in part on the monitoring for the attempt to change the application settings.

21. A computer program product embodied in a non-transitory computer readable medium and comprising computer instructions for:
automatically onboarding a software-as-a-service (SaaS) application for an enterprise by determining a set of application settings for the SaaS application based on a screenshot of a settings page for the SaaS application using a machine learning model;
performing a monitoring, using the machine learning model, for an attempt to change the application settings; and
enforcing a policy based at least in part on the monitoring for the attempt to change the application settings.

22. A system, comprising:
one or more processors configured to:
obtain a training set of configuration settings page samples for a set of software-as-a-service (SaaS) applications;
obtain a set of publicly available documentation for a plurality of SaaS applications; and
finely tune a large language model (LLM) to identify SaaS application configurations, wherein the LLM is fine-tuned based at least in part on (i) the training set of configuration settings page samples, and (ii) the set of publicly available documentation; and
a memory coupled to the one or more processors and configured to provide the one or more processors with instructions.

23. A method, comprising:
obtaining a training set of configuration settings page samples for a set of software-as-a-service (SaaS) applications;
obtaining a set of publicly available documentation for a plurality of SaaS applications; and
finely tuning a large language model (LLM) to identify SaaS application configurations, wherein the LLM is fine-tuned based at least in part on (i) the training set of configuration settings page samples, and (ii) the set of publicly available documentation.
